(19) United States
(12) Patent Application Publication
(10) Pub. No.: US 2026/0281779 A1
(43) Pub. Date: Sep. 17, 2026

(54) Assistance Information for Handling of QoE Reporting

(71) Applicant: Telefonaktiebolaget LM Ericsson (publ), Stockholm (SE)

(72) Inventors: Filip Barac, Huddinge (SE); Luca Lunardi, Genova (IT); Robert Petersen, Linköping (SE); Cecilia Eklöf, Täby (SE); Johan Rune, Lidingö (SE)

(21) Appl. No.: 19/475,526

(22) PCT Filed: Apr. 16, 2024
(86) PCT No.: PCT/SE2024/050368

§ 371 Date: Oct. 15, 2025

Related U.S. Application Data
(60) Provisional application No. 63/459,817, filed on Apr. 17, 2023.

(51) Int. Cl. H04W 24/10; H04W 24/08

(52) U.S. Cl. CPC H04W 24/10; H04W 24/08

(57) ABSTRACT

Methods, systems, and apparatuses for handling quality-of-experience, QoE, measurement reporting in a communications network An example method comprises a first network node assembling (310) a QoE measurement configuration, the QoE measurement configuration comprising one or more attributes indicative of at least one absolute priority or relative priority for one or more QoE measurements, and the first network node sending (320) the QoE measurement configuration towards a second network node. The method further comprises the second network node configuring (330) one or more user equipments, UEs, to perform QoE measurements based on the QoE measurement configuration and the second network node, responsive to at least a first load condition in or associated with the second network node, signaling (340) one or more of the UEs to pause reporting of one or more of the QoE measurements based on the one or more attributes.

### TECHNICAL FIELD

The present disclosure is generally related to wireless networks and is more particularly related to the handling of quality-of-experience (QoE) measurements and QoE measurement reporting in such networks.

### BACKGROUND

Overall Architecture of NG-RAN The overall architecture for the next-generation radio access network (NG-RAN) is illustrated in FIG. 1. The NG-RAN consists of a set of gNBs connected to the 5GC through the NG interface.
NOTE: As specified in 38.300, NG-RAN could also consist of a set of ng-eNBs, an ng-eNB may consist of an ng-eNB-CU and one or more ng-eNB-DU(s). An ng-eNB-CU and an ng-eNB-DU is connected via W1 interface. The general principle described in this section also applies to ng-eNB and W1 interface, if not explicitly specified otherwise.

An gNB can support FDD mode, TDD mode or dual mode operation.

gNBs can be interconnected through the Xn interface.

A gNB may consist of a gNB-CU and one or more gNB-DU(s). A gNB-CU and a gNB-DU is connected via F1 interface.

One gNB-DU is connected to only one gNB-CU.
NOTE: In case of network sharing with multiple cell ID broadcast, each Cell Identity associated with a subset of PLMNs corresponds to a gNB-DU and the gNB-CU it is connected to, i.e., the corresponding gNB-DUs share the same physical layer cell resources.
NOTE: For resiliency, a gNB-DU may be connected to multiple gNB-CUs by appropriate implementation.

NG, Xn and F1 are logical interfaces.

For NG-RAN, the NG and Xn-C interfaces for a gNB consisting of a gNB-CU and gNB-DUs, terminate in the gNB-CU. For EN-DC, the S1-U and X2-C interfaces for a gNB consisting of a gNB-CU and gNB-DUs, terminate in the gNB-CU. The gNB-CU and connected gNB-DUs are only visible to other gNBs and the 5GC as a gNB. A possible deployment scenario is described in Annex A.

The node hosting user plane part of NR PDCP (e.g., gNB-CU, gNB-CU-UP, and for EN-DC, MeNB or SgNB depending on the bearer split) shall perform user inactivity monitoring and further informs its inactivity or (re)activation to the node having C-plane connection towards the core network (e.g., over E1, X2). The node hosting NR RLC (e.g., gNB-DU) may perform user inactivity monitoring and further inform its inactivity or (re)activation to the node hosting control plane, e.g., gNB-CU or gNB-CU-CP.

UL PDCP configuration (i.e., how the UE uses the UL at the assisting node) is indicated via X2-C (for EN-DC), Xn-C (for NG-RAN) and F1-C. Radio Link Outage/Resume for DL and/or UL is indicated via X2-U (for EN-DC), Xn-U (for NG-RAN) and F1-U.

The NG-RAN is layered into a Radio Network Layer (RNL) and a Transport Network Layer (TNL).

The NG-RAN architecture, i.e., the NG-RAN logical nodes and interfaces between them, is defined as part of the RNL.

For each NG-RAN interface (NG, Xn, F1) the related TNL protocol and the functionality are specified. The TNL provides services for user plane transport, signaling transport.

In NG-Flex configuration, each NG-RAN node is connected to all AMFs of AMF Sets within an AMF Region supporting at least one slice also supported by the NG-RAN node. The AMF Set and the AMF Region are defined in 3GPP TS 23.501, v18.1.0.

If security protection for control plane and user plane data on TNL of NG-RAN interfaces has to be supported, NDS/IP 3GPP TS 33.501, v18.1.0 shall be applied.

Overall architecture for separation of gNB-CU-CP and gNB-CU-UP

The overall architecture for separation of gNB-CU-CP and gNB-CU-UP is depicted in Error!

Reference source not found, and specified in 3GPP TS 37.483, v17.8.0.
A gNB may consist of a gNB-CU-CP, multiple gNB-CU-UPs and multiple gNB-DUs;
The gNB-CU-CP is connected to the gNB-DU through the F1-C interface;
The gNB-CU-UP is connected to the gNB-DU through the F1-U interface;
The gNB-CU-UP is connected to the gNB-CU-CP through the E1 interface;
One gNB-DU is connected to only one gNB-CU-CP;
One gNB-CU-UP is connected to only one gNB-CU-CP;
NOTE 1: For resiliency, a gNB-DU and/or a gNB-CU-UP may be connected to multiple gNB-CU-CPs by appropriate implementation.
One gNB-DU can be connected to multiple gNB-CU-UPs under the control of the same gNB-CU-CP;
One gNB-CU-UP can be connected to multiple DUs under the control of the same gNB-CU-CP;
NOTE 2: The connectivity between a gNB-CU-UP and a gNB-DU is established by the gNB-CU-CP using Bearer Context Management functions.
NOTE 3: The gNB-CU-CP selects the appropriate gNB-CU-UP(s) for the requested services for the UE. In case of multiple CU-UPs they belong to same security domain as defined in TS 33.210.
NOTE 4: Data forwarding between gNB-CU-UPs during intra-gNB-CU-CP handover within a gNB may be supported by Xn-U.

### QoE Framework: “Regular” QoE

Quality of Experience (QoE) measurements, also referred to as “application layer measurements”, have been specified for LTE and UMTS and are being specified for NR in 3GPP release 17. The purpose of the application layer measurements is to measure the end user experience when using certain applications. Currently, QoE measurements for streaming services and for MTSI (Mobility Telephony Service for IMS) services are supported. For NR, it is likely that at least virtual reality (VR) is added to the list of services for which QoE measurements are specified and supported.

The solutions in LTE and UMTS are similar with the overall principles as follows. Quality of Experience Measurement Collection (QMC) enables configuration of application layer measurements in the UE and transmission of QoE measurement result files (commonly referred to as QoE reports) to the network by means of Radio Resource Control (RRC) signaling. An application layer measurement configuration (also called QoE measurement configuration or QoE configuration) that the RAN receives from the OAM system or the CN is encapsulated in a transparent container, which is forwarded to a UE in a downlink RRC message. An application layer measurement report (also called QoE report) that the UE Access Stratum (UE AS) or UE RRC layer receives from the UE's higher layer (application layer) is encapsulated in a transparent container and sent to network in an uplink RRC message. The RAN then forwards the QoE report to a Measurement Collector Entity (MCE).

In 3GPP release 17, a new study item for “Study on NR QoE management and optimizations for diverse services” for NR was approved and concluded. The specification work for 3GPP release 17 is still ongoing. The purpose of the study item is to study solutions for QoE measurements in NR. QoE management in NR will not just collect the quality of experience parameters of streaming services but also consider the typical performance requirements of diverse services, such as augmented reality/virtual reality (AR/VR) and ultra-reliable low-latency communications (URLLC), of which at least VR seems to be covered in 3GPP release 17. Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an IP address of the entity to which the collected measurement results (i.e., the QoE reports) should be sent (often referred to as a MCE, spelled out as Measurement Collector Entity or Measurement Collection Entity, but the entity may sometimes also be referred to as a Trace Collection Entity), and a set of instructions of which type of measurements that should be performed and details of how these measurements are to be performed. These instructions are intended for the application layer in the UE and are placed in a “container” that the network entities handling it, e.g., forwarding it to the UE, as well as the UE Access Stratum, cannot interpret and do not try to read. The currently specified service types are MTSI and streaming service (DASH), and in 3GPP release 17, at least service type VR will be added. An area scope is defined in terms of cells or network related areas. In UMTS, an area scope is defined as either a list of cells, a list of routing areas or a list of tracking areas. In LTE, an area scope is defined as either a list of cells or a list of tracking areas. In NR, an area scope will be defined as either a list of cells or a list of tracking areas.

QoE and the corresponding QoE configurations come in two flavors: management-based QoE configuration and signaling-based QoE configuration. In both cases, the QoE configuration originates in the OAM system or some other administrational entity, e.g., dealing with customer satisfaction. All of these entities are in this document referred to as the OAM system (where the OAM system also contains further entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and that also fulfill any other relevant condition, such as supporting the concerned application/service type) and sends the m-based QoE configuration to these UEs.

With signaling-based QoE (s-based QoE), the OAM system is interested in collecting QoE measurement results from a specific UE, e.g., because the user of the UE has filed a complaint. The OAM system sends the s-based QoE configuration to the Home Subscriber Server (HSS), in EPS/LTE, or the Unified Data Manager (UDM), in 5GS/NR, which forwards the QoE configuration to the UE's current core network node (CN), e.g., to an MME in EPS/LTE or an AMF in 5G/NR. The CN then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality will be logically separated from the Trace functionality, but it will still partly reuse the Trace signaling mechanisms. In NR and LTE, a globally unique QoE reference (formed of MCC+MNC+QMC ID, where the QMC ID is a string of 24 bits) will be associated with each QoE configuration. The QoE reference is included in the container with measurement instructions and also sent to the RAN (i.e., the gNB in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE. The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE measurement results (QoE reports) are sent from the UE application layer to the UE Access Stratum, which forwards them to the RAN, which forwards them to the MCE. These QoE measurement results are placed in a “container” that is uninterpretable for the UE Access Stratum and the RAN. QoE reporting can be configured to be periodic or only sent at the end of an application session. Furthermore, the RAN can instruct the UE to pause QoE reporting, e.g., in case the cell/gNB is in a state of overload.

The RAN is not aware of when an application session with an associated QoE measurement session is ongoing and the UE Access Stratum is also not automatically aware of this. To alleviate this, session start/stop indications can be introduced, which will be sent from the application layer in the UE to the UE AS and from the UE AS to the RAN. A session stop indication may be implicit in the form of a QoE report sent when the application session and the associated QoE measurement session are concluded.

The RAN may decide to release a QoE configuration in a UE at any time, as an implementation-based decision. Typically, it is done when the UE has moved outside an area configured for the QoE measurements, commonly referred to as the area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

### QoE Framework: RAN-Visible QoE (RVQoE)

For NR, 3GPP Rel-17 introduced RAN-visible QoE measurements, and a general description can be found in 3GPP TS 38.300 v17.0.0 clause 21.4.

RAN-visible QoE measurements are configured by the NG-RAN node, where a subset of QoE metrics is reported from the UE as an explicit information element (IE) readable by the NG-RAN node. RAN-visible QoE measurements (e.g., RAN-visible QoE metrics, RAN-visible QoE values) could be utilized by the NG-RAN node for network optimization. RAN-visible QoE measurements are supported for the DASH streaming and VR services. The NG-RAN node configures the RAN-visible QoE measurement to collect all or some of the available RAN-visible QoE metrics, where an indication of metric availability is received by the NG-RAN node from the OAM or CN. The set of available RAN-visible QoE metrics is a subset of the metrics that are already configured as part of QoE measurement configuration encapsulated in the transparent container. The PDU session ID(s) corresponding to the service that is subject to QoE measurements can also be reported by the UE, along with the RAN-visible QoE measurement results.

A request for collecting QoE measurements not visible to RAN (also called OAM-QoE in R3-223290) is started from OAM and identified by a QoE Reference. A definition for this identifier can be found e.g., in 3GPP TS 28.405 v17.1.0, clause 5.2:
The QoE reference parameter specifies the network request session. The QoE reference shall be globally unique therefore it is composed as follows:
MCC+MNC+QMC ID, where the MCC and MNC are coming with the QMC activation request from the management system to identify one PLMN containing the management system, and QMC ID is a 3 byte Octet String.
The QMC ID is generated by the management system or the operator.
It is used to identify the QoE measurement collection job in the traffic nodes and in the measurement collection centre.

The UE AS layer can report to a gNB the RAN-visible QoE measurements in RRC format and a UE Application Layer can be configured for performing more application layer measurements at the same time (in NR Rel-17 up to 16) and, e.g., in 3GPP TS 38.331 v17.4.0, an application layer measurement is identified by the MeasConfigAppLayerId IE.

In a gNB, RAN-visible QoE information can be transferred from gNB-CU to the gNB-DU in a procedure described in 3GPP TS 38.473 v17.0.0. The procedure is UE-associated, i.e., it is specific for a UE. The corresponding excerpts from TS 38.473 V17.1.0 are shown below.

### Begin 3GPP Specification Excerpts

### 8.16.1 QoE Information Transfer

The purpose of the QoE Information Transfer procedure is to transfer RAN-visible QoE information from the gNB-CU to the gNB-DU. The procedure uses UE-associated signalling.

### [FIG. 8.16.1.2-1 Omitted]

The gNB-CU initiates the procedure by sending the QOE INFORMATION TRANSFER message to the gNB-DU.

If the QoE Information List IE is included in QOE INFORMATION TRANSFER message, the gNB-DU may take it into account according to TS 38.300 [6].

### 9.2.16.1 QoE Information Transfer

This message is sent by a gNB-CU to a gNB-DU, to indicate information related to RAN-visible QoE.

Direction: gNB-CU® gNB-DU.

| | | | | | | |
|---|---|---|---|---|---|---|
| IE/Group | | | | Semantics | | Assigned |
| Name | Presence | Range | IE type and reference | description | Criticality | Criticality |

| | | | | |
|---|---|---|---|---|
| Message | M | 9.3.1.1 | YES | ignore |
| Type | | | | |
| gNB-CU UE | M | 9.3.1.4 | YES | reject |
| F1AP ID | | | | |
| gNB-DU UE | M | 9.3.1.5 | YES | reject |
| F1AP ID | | | | |
| QoE | | 0 . . . 1 | YES | ignore |
| Information | | | | |
| List | | | | |
| >QoE | | 1 . . . | Each | ignore |
| Information | | <maxnoofQoEInformation> | | |
| Item | | | | |
| >>QoE | O | 9.3.1.260 | — | — |
| Metrics | | | | |

| Range bound | Explanation |
|---|---|
| maxnoofQoEInformation | Maximum no. of QoE information for one UE, |
| | the maximum value is 16. |

### 9.3.1.260 QoE Metrics

This IE provides the RAN-visible QoE measurement report to gNB-DU.

| | | | | |
|---|---|---|---|---|
| IE/Group | | | IE type and | Semantics |
| Name | Presence | Range | reference | description |

| | | | |
|---|---|---|---|
| Buffer Level | O | OCTET | As defined in TS |
| | | STRING | 38.331 [8]. |
| Playout Delay | O | OCTET | As defined in TS |
| | | STRING | 38.331 [8]. |

### End 3GPP Specification Excerpts

In contribution R3-223128 to 3GPP TSG-RAN WG3 Meeting #116-e, the association of RAN-visible QoE report to a reference is discussed:
In FLAP a list containing currently agreed RVQoE metric is transferred over F1 using UE-associated signalling. But the reports are not associated with e.g., any reference or other id. So the gNB-DU will not know how many different application sessions that provide reports, and the currently defined signalling will therefore not allow the gNB-DU to distinguish between QoE reports coming from the different application sessions. Also, the gNB-DU will not be able to group reports that it successively receives from a given application session and will therefore not be able to trace e.g., any tendencies in the reported data.
Candidate reference or other ID that could solve this issue would typically be the QoE reference or the short RRC id (measConfigAppLayerId) allocated by the UE. In the F1AP CR submitted to the present meeting in R3-223131, we propose to use the QoE reference, but the ultimate choice may be subject for further evaluation.

In the same contribution, the following proposal is made according to the reported discussion:
Proposal 3: RAN3 to discuss and agree on identifying RVQoE report information over F1 using QoE Reference or short RRC id (measConfigAppLayerId).

### Signaling Radio Bearer (SRB)

Signaling Radio Bearers are configured in the UE for transmission of control plane message to and from the UE. In the current 3GPP specifications, five different SRBs may be configured. SRB0 is used for initial RRC setup, before any security is activated. SRB1 is used for most RRC messages and SRB2 for NAS messages.

If the UE is configured with dual connectivity (DC), SRB1 is used for communicating with the Master Node (MN). The UE may in DC also be configured with SRB3, which is used for direct communication between the UE and the Secondary Node (SN).

For the transmission of QoE and RVQoE reports, a dedicated SRB4 has been defined. SRB4 is, in Release 17 of the 3GPP specifications, only being used for transmission of QoE and RVQoE reports in the RRC message MeasurementReportAppLayer, to a Master Node.

### Overload Detection in RAN

Overload detection is possible in the RAN. In NG-RAN, gNB-DU can indicate to the gNB-CU its status of overload by means of the F1AP “GNB-DU STATUS INDICATION” message as described in the excerpt from 3GPP TS 38.473 v17.4.1 below.

### Begin 3GPP Specification Excerpts

8.2.7 gNB-DU Status Indication

The purpose of the gNB-DU Status Indication procedure is informing the gNB-CU that the gNB-DU is overloaded so that overload reduction actions can be applied. The procedure uses non-UE associated signalling.
[Figure omitted]

If the gNB-DU Overload Information IE in the GNB-DU STATUS INDICATION message indicates that the gNB-DU is overloaded, the gNB-CU shall apply overload reduction actions until informed, with a new GNB-DU STATUS INDICATION message, that the overload situation has ceased. The detailed overload reduction policy is up to gNB-CU implementation

### 9.2.1.15 GNB-DU Status Indication

This message is sent by the gNB-DU to indicate to the gNB-CU its status of overload.
Direction: gNB-DU→gNB-CU

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message Type | M | 9.3.1.1 | YES | ignore |
| Transaction ID | M | 9.3.1.23 | YES | reject |
| gNB-DU | M | ENUMERATED | YES | reject |
| Overload | | (overloaded, | | |
| Information | | not-overloaded) | | |

### End 3GPP Specification Excerpts

A similar procedure is defined in NG-RAN for the E1 interface. The gNB-CU-UP can indicate to the gNB-CU-CP its status of overload by means of the F1AP “GNB-CU-UP STATUS INDICATION” message as described below (see 3GPP TS 38.463 v16.12.0).

### Begin 3GPP Specification Excerpts

8.2.8 gNB-CU-UP Status Indication

The purpose of the gNB-CU-UP Status Indication procedure is to inform the gNB-CU-CP that the gNB-CU-UP is overloaded so that overload reduction actions can be applied. The procedure uses non-UE associated signalling.
[Figure omitted]

The gNB-CU-UP initiates the procedure by sending the GNB-CU-UP STATUS INDICATION message to the gNB-CU-CP.

If the gNB-CU-UP Overload Information IE in the GNB-CU-UP STATUS INDICATION message indicates that the gNB-CU-UP is overloaded, the gNB-CU-CP shall apply overload reduction actions until informed, with a new GNB-CU-UP STATUS INDICATION message, that the overload situation has ceased.

The detailed overload reduction policy is up to gNB-CU-CP implementation.

### 9.2.1.18 GNB-CU-UP Status Indication

This message is sent by the gNB-CU-UP to indicate to the gNB-CU-CP its status of overload.
Direction: gNB-CU-UP→gNB-CU-CP

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message Type | M | 9.3.1.1 | YES | reject |
| Transaction ID | M | 9.3.1.53 | YES | reject |
| gNB-CU-UP | M | ENUMERATED | YES | reject |
| Overload | | (overloaded, | | |
| Information | | not-overloaded) | | |

### End 3GPP Specification Excerpts

A similar procedure is defined for X2 interface. The en-gNB can indicate to the eNB its status of overload by means of the X2AP “GNB STATUS INDICATION” message as described below (see 3GPP TS 38.423 v 17.40.0).

### Begin 3GPP Specification Excerpts

### 8.7.17 gNB Status Indication

The purpose of the gNB Status Indication procedure is to inform the eNB that the en-gNB is overloaded so that overload reduction actions can be applied. The procedure uses non-UE associated signalling.
[Figure omitted]

If the gNB Overload Information IE in the GNB STATUS INDICATION message is set to “overloaded”, the eNB shall apply overload reduction actions until it receives a subsequent GNB STATUS INDICATION message with gNB Overload Information IE set to “not-overloaded”.

The detailed overload reduction policy is up to eNB implementation.

If case of network sharing with multiple cell ID broadcast with shared X2-C signalling transport, as specified in TS 36.300, the GNB STATUS INDICATION message shall contain the Interface Instance Indication IE to identify the corresponding interface instance.

### 9.1.4.27 GNB Status Indication

This message is sent by the en-gNB to indicate to the eNB its status of overload.
Direction: en-gNB→eNB.

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message | M | 9.2.13 | YES | ignore |
| Type | | | | |
| gNB | M | ENUMERATED | YES | ignore |
| Overload | | (overloaded, not- | | |
| Information | | overloaded, . . . ) | | |
| Interface | O | 9.2.143 | YES | reject |
| Instance | | | | |
| Indication | | | | |

### End 3GPP Specification Excerpts

### Overload Detection in Core Network

3GPP TS 38.413 v17.4.1 specifies the Overload Start and Overload Stop procedures. The purpose of Overload Start procedure is to inform an NG-RAN node to reduce the signalling load towards the concerned AMF. The purpose of Overload Stop procedure is to signal to an NG-RAN node the AMF is connected to that the overload situation at the AMF has ended and normal operation shall resume. Excerpts from 3GPP TS 38.413 v17.4.1 are provided below:

### Begin 3GPP Specification Excerpts

### 8.7.7 Overload Start

### 8.7.7.1 General

The purpose of the Overload Start procedure is to inform an NG-RAN node to reduce the signalling load towards the concerned AMF. The procedure uses non-UE associated signalling.

### 8.7.7.2 Successful Operation

[Figure omitted]

The NG-RAN node receiving the OVERLOAD START message shall assume the AMF from which it receives the message as being in an overloaded state.

If the Overload Action IE is included the AMF Overload Response IE within the OVERLOAD START message, the NG-RAN node shall use it to identify the related signalling traffic. When the Overload Action IE is set to
“reject RRC connection establishments for non-emergency mobile originated data transfer” (i.e., reject traffic corresponding to RRC cause “mo-data”, “mo-SMS”, “mo-VideoCall” and “mo-VoiceCall” in TS 38.331 or “mo-data” and “mo-VoiceCall” in TS 36.331 [21]), or
“reject RRC connection establishments for signalling” (i.e., reject traffic corresponding to RRC cause “mo-data”, “mo-SMS”, “mo-signalling”, “mo-VideoCall” and “mo-VoiceCall” in TS 38.331 or “mo-data”, “mo-signalling” and “mo-VoiceCall” in TS 36.331 [21]), or
“only permit RRC connection establishments for emergency sessions and mobile terminated services” (i.e., only permit traffic corresponding to RRC cause “emergency” and “mt-Access” in TS 38.331 or in TS 36.331 [21]), or
“only permit RRC connection establishments for high priority sessions and mobile terminated services” (i.e., only permit traffic corresponding to RRC cause “highPriorityAccess”, “mps-PriorityAccess”, “mcs-PriorityAccess” and “mt-Access” in TS 38.331 or “highPriorityAccess”, “mo-ExceptionData” and “mt-Access” in TS 36.331 [21]),
the NG-RAN node shall:
if the AMF Traffic Load Reduction Indication IE is included in the OVERLOAD START message, reduce the signalling traffic by the indicated percentage,
otherwise ensure that only the signalling traffic not indicated as to be rejected is sent to the AMF
If the Overload Start NSSAI List IE is included in the OVERLOAD START message, the NG-RAN node shall:
if the Slice Traffic Load Reduction Indication IE is present, reduce the signalling traffic by the indicated percentage for the UE(s) whose requested NSSAI only include S-NSSAI(s) contained in the Overload Start NSSAI List IE, and the signalling traffic indicated as to be reduced by the Overload Action IE in the Slice Overload Response IE if the IE is present,
otherwise ensure that only the signalling traffic from UE(s) whose requested NSSAI includes S-NSSAI(s) other than the ones contained in the Overload Start NSSAI List IE, or the signalling traffic not indicated as to be reduced by the Overload Action IE in the Slice Overload Response IE for the UE(s) if the requested NSSAI matched, is sent to the AMF.

If an overload control is ongoing and the NG-RAN node receives a further OVERLOAD START message, the NG-RAN node shall replace the contents of the previously received information with the new one.

### 8.7.7.3 Abnormal Conditions

Void.

### 8.7.8 Overload Stop

### 8.7.8.1 General

The purpose of the Overload Stop procedure is to signal to an NG-RAN node the AMF is connected to that the overload situation at the AMF has ended and normal operation shall resume. The procedure uses non-UE associated signalling.

### 8.7.8.2 Successful Operation

[Figure omitted]

The NG-RAN node receiving the OVERLOAD STOP message shall assume that the overload situation at the AMF from which it receives the message has ended and shall resume normal operation for the applicable traffic towards this AMF.

### End 3GPP Specification Excerpts

### 3GPP Rel-18 QoE Work Item

For 3GPP Rel-18, 3GPP document RP-221803 describes the Work Item “Enhancement on NR QoE management and optimizations for diverse services.” Among others, it indicates the following objectives:
Support for new service type, such as AR, MR, MBS and other new service type defined or to be supported by SA4. Support RAN-visible parameters for the additional service types, and the existing service if needed, and the coordination with SA4 is needed [RAN3, RAN2].
   Specify the new service and the existing service defined or to be supported by SA4, combined with high mobility scenarios, e.g., High Speed Trains.
Specify for QoE measurement configuration and collection in RRC_INACTIVE and RRC_IDLE states for MBS, at least for broadcast service [RAN3, RAN2].
   Specify the mechanism to support the alignment of the existing radio related measurement and QoE reporting.
Left-over features from Rel-17, as well as the enhancements of existing features which are not included in Rel-17 normative phase, should be supported in Rel-18 if consensus on benefits are reached [RAN3, RAN2].
   Specify per-slice QoE measurement configuration enhancement.
   Specify RAN-visible QoE enhancements for QoE value, RAN-visible QoE trigger event, RAN-visible QoE Report over F1.
   Specify QoE reporting handling enhancement for overload scenario

During previous 3GPP meetings, RAN3 discussed whether the RAN can receive information to handle the QoE reporting in case of RAN overload. At RAN3 #119, the following agreement was reached:
In case assistance information for handling of QoE reporting upon RAN overload is sent to the RAN, it is sent together with QoE measurement configuration. RAN3 to further discuss what the assistance information is. From RAN3 perspective, there is no need to send assistance information to UE.

As indicated by the agreement, RAN3 should decide the details concerning the assistance information.

In R3-231762, it is proposed that “assistance information” is a priority for each QoE measurement, as described below. It is also proposed that OAM can receive information from other consumers of QoE reports and set the assistance information considering the input received from other consumers:
There are mainly two remaining controversial issues, which are first what the assistance information is, and the second who is the consumer of the QoE measurements.
Regarding the first issue, in our understanding, the assistance information is the priority for each QoE measurement (per QoE reference ID). Setting the granularity of priority as such can avoid mess and confusion when there are multiple consumers, e.g., one set the priority according to service type, another one set the priority according to slice, but offers flexibility and a consistent rule to prioritize the pause/resume of some QoE measurements in case of overload.
Proposal 3: The assistance information is the priority for each QoE measurement.
As for the second issue, we agree there can be multiple consumers for QoE measurement, i.e, OAM is not the only consumer for QoE. However, we understand that the initial goal of QoE is for the good of network optimization, where the consumer is OAM. The other consumers are just using the QoE report for some extra purposes. Take NWDAF for instance, it simply obtains the data from OAM for AI/ML data analysis. Therefore, for other consumers except OAM, they should follow the priorities set by OAM. Moreover, we think other consumers can participate in setting the assistance information in an implicit way. Specifically, other consumers can actually check manually the current priority set by OAM. If these consumers are not satisfied with the current priority, they can simply let OAM know, ask OAM to configure a new QoE measurement with a higher priority.
Proposal 4: OAM is not the only consumer of QoE measurement, where other consumers can implicitly affect the assistance information set by OAM.

### SUMMARY

During Rel-17 and Rel-18 3GPP QoE work items, RAN3 discussed the mechanism for the OAM system to configure the RAN with priorities according to which the QoE measurement reports will be delivered to the RAN, e.g., during RAN overload. This scenario will be referred to herein as “Scenario 1.” In particular, the priority assigned to a QoE measurement configuration will determine whether the corresponding reporting from the UE will be paused during the overload. The discussed solutions are OAM-centric, where the OAM system sets the reporting priorities.

Furthermore, in Rel-18, 3GPP agreed that, for certain services, e.g., applications delivered to the UE via the MBS communication service, the UE may conduct QoE measurements and store the QoE reports while in RRC_IDLE and RRC_INACTIVE states, provided that the application session is ongoing while the UE is in these states. After the UE comes back to RRC_CONNECTED state, the UE delivers the stored reports to the network. This scenario is herein referred to as “Scenario 2.”

Previously discussed solutions, however, overlook the fact that some consumers of QoE measurement reports, such as the NWDAF and forthcoming RAN automation functions, are not in the OAM system, which means that it is not always appropriate that the OAM system is the entity deciding on prioritization of reporting in the above two scenarios.

An additional problem is that previously discussed solutions place the control and responsibility of prioritizing which QoE measurement sessions which should be allowed to transmit the QoE reports they generate in a RAN external entity. This leaves no room for the RAN to take other circumstances into account, e.g., related to the fact that a likely reason for not allowing the UE to send all QoE reports is that the RAN is highly loaded or overloaded. This may lead to suboptimal resource utilization, since it only takes one of two relevant aspects into account, i.e. the importance of the information in the QoE reports to the consumers of the reports is taken into account, but not the impact of different QoE measurement session's QoE reports on the resource situation in the RAN.

In U.S. Provisional Application Ser. No. 63/400,207, filed 23 Aug. 2022, the entire contents of which are incorporated herein by reference, a solution for configuring the RAN node with how to handle QoE reporting is disclosed, where the handling is determined by the priority, assigned by the measurement consumer (i.e., the consumer of the QoE measurement report(s)) or based on an attribute provided by the measurement consumer. The present disclosure introduces several additions to that approach:
The solutions are extended to a second scenario: handling of QoE reporting for the QoE reports collected and stored by the UE while the UE was in RRC_IDLE or RRC_INACTIVE state.
Additional information (herein referred to as “attributes/priorities”), based on which the QoE reporting is handled, are provided for both scenarios of interest.

Embodiments described in detail herein include a method, in a network, for handling quality-of-experience (QoE) measurement reporting, where the method comprises a first network node assembling a QoE measurement configuration, the QoE measurement configuration comprising one or more attributes indicative of at least one absolute priority or relative priority for one or more QoE measurements, and the first network node sending the QoE measurement configuration towards a second network node. The method further comprises the second network node configuring one or more user equipments (UEs) to perform QoE measurements, based on the QoE measurement configuration and the second network node, responsive to at least a first load condition in or associated with the second network node, signaling one or more of the UEs to pause reporting of one or more of the QoE measurements, based on the one or more attributes.

Other embodiments detailed herein include a method, in a user equipment (UE) operating in a network, for handling quality-of-experience (QoE) measurement reporting, where the method comprises receiving, from a network node in the network, a QoE measurement configuration, the QoE measurement configuration comprising one or more attributes indicative of at least one absolute priority or relative priority for one or more QoE measurements. This method further comprises the UE, responsive to at least a first condition, pausing reporting of one or more of the QoE measurements, based on the one or more attributes.

Also detailed herein is another method, in a user equipment (UE) operating in a network, for handling quality-of-experience (QoE) measurement reporting, where the method again comprises receiving, from a network node in the network, a QoE measurement configuration. This method further comprises the UE, based on one or more attributes included in the QoE measurement configuration, selecting, from among multiple network nodes to which the UE is connected, a network node to which QoE measurements according to the QoE measurement configuration are to be reported.

Still another method, in a user equipment (UE) operating in a network, for handling quality-of-experience (QoE) measurement reporting, comprises the UE receiving, from a network node in the network, a QoE measurement configuration, transitioning from connected mode to an inactive state, with respect to the network, performing QoE measurements while in the inactive state, and storing the QoE measurements performed while in the inactive state. This method further comprises the UE returning to connected mode from the inactive state and initiating reporting of the stored QoE measurements to network, in response to said returning.

Apparatuses and systems corresponding to these methods and several variations thereof are also described in detail below.

The solutions described herein provide the advantage to flexibly handle the reporting of QoE measurements in at least two scenarios. First, they provide for the handling of QoE reporting in the case of overload (in particular in case of overload determined at the network node due to, or at least partly due to, receiving QoE measurements from the UE(s)). Second, they provide for handling of QoE reporting for reports collected and stored at the UE while the UE was performing QoE measurements in RRC_IDLE or RRC_INACTIVE states.

Furthermore, the solutions described herein enable and facilitate a RAN node to take other important aspects into account when prioritizing QoE reports than priorities set by RAN external entities, e.g., the impact of the QoE reports from different QoE measurement sessions on the resource situation in the RAN.

When QoE measurements can be consumed by different entities of a communication network, the operator can make sure that a first consumer for which reception of QoE measurements is more critical/important compared to the need of a second consumer, should take precedence over the second consumer.

### BRIEF DESCRIPTION OF THE FIGURES

FIG. 1 illustrates the NG-RAN overall architecture as defined in 3GPP TS 38.401 v17.4.0.

FIG. 2 shows the overall architecture for separation of gNB-CU-CP and gNB-CU-UP.

FIG. 3 is a process flow diagram illustrating an example method according to embodiments disclosed herein.

FIG. 4, FIG. 5, and FIG. 6 each illustrate an example method carried out by a UE, according to embodiments disclosed herein.

FIG. 7 is a block diagram illustrating an example system, according to various embodiments described herein.

FIG. 8 is a block diagram of an example UE.

FIG. 9 is a block diagram of an example network node.

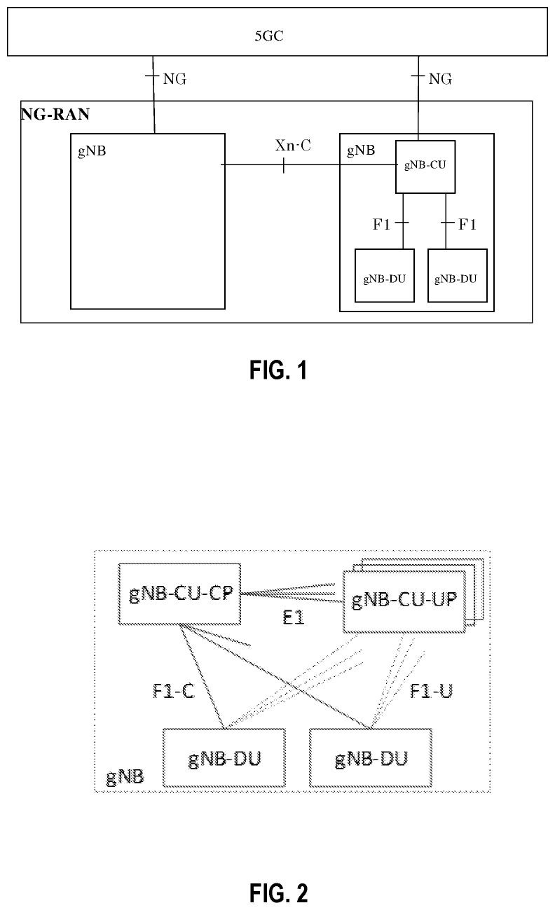

### DETAILED DESCRIPTION

In the present document, the following generalizations, definitions, and disclaimers are applicable:
The terms “application layer measurement configuration”, “application measurement configuration”, “QoE measurement configuration”, “QoE configuration”, “QoE measurement and reporting configuration” and “QMC configuration” are used interchangeably. But note that the “QMC configuration file” is not an equivalent term, but instead refers to the part of the QoE configuration consisting of an XML file containing instructions of QoE metrics to be collected etc.
All references to the application layer are with respect to the application layer of the UE (since RAN nodes do not have an application layer).
The term “service” is often used as a short notation for “service type”, therefore “service” and “service types” can be seen as interchangeably unless explicitly stated.
The solution proposed in this document applies to both signaling- and management-based QoE measurements (but may also optionally be restricted to apply to only one of them).
The terms “QoE report”, “QoE reporting” and “QoE measurement report” are used interchangeably. Similarly, the terms “RAN-visible QoE report”, “RAN-visible QoE measurement report”, “RVQoE report” and “RVQoE measurement report” are used interchangeably.
The terms “QoE report”, “QoE reporting” and “QoE measurement report”, unless explicitly stated, can be used also to indicate the reporting of RAN-visible QoE measurements.
The terms “access stratum” and “radio layer” are used interchangeably when referring to a UE.
The term “session” may refer to either a QoE measurement session or an application session or an application session for which QoE measurement is applied.
The term “session” may refer to either a QoE measurement session or an application session or an application session for which QoE measurement is applied.
The solution described herein applies to UMTS, LTE and NR, as well as to future radio access technologies (RATs) such as 6G.
The solution is described on the example of management based QoE measurements (i.e., their corresponding RVQoE measurements), but it is equally applicable to both management-based and signalling-based QoE measurements, as well as their corresponding RVQoE measurements.
A network node can be a RAN node, an OAM, a Core Network node, an OAM, an SMO, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-DU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a Cloud-based network function, a Cloud-based centralized training node, a Network Data Analytics Function (NWDAF), a Fault handling management functions, The OAM system or part thereof, An Element Manager, A Network Management System, RAN automation functions, A function in a RAN node deployed in split architecture (e.g., a gNB-CU-CP), O-RAN node, or part thereof, Split RAN node, A distributed part of the management system in a RAN or core network node, SON function, Management function, Assurance and analytics function, Performance calculating function, A charging node, A node hosting the training function of an AI/ML model, A node hosting the data collection function of an AI/ML model, A node hosting the inference function of an AI/ML model, Any administrational entity.
In this document, the term “node” refers to a physical node or a logical node, with the understanding that the logical node is implemented in hardware, e.g., in a single physical node along with one or more other logical nodes or in a distributed manner, among multiple physical nodes. It may also be referred to as an “entity”. While the terms “entity” and “logical node” can generally be understood as abstractions, e.g., as groupings of functionalities, the use of those terms herein in connection with describing specific embodiments of the techniques, apparatuses, and systems described herein should be understood as referring to physical implementations of the functionalities associated with the “entity” or “logical node.”
When mentioned in this document, priorities or attributes of various kind with the purpose of impacting the RAN's assessment of expected QoE reporting, e.g., in terms of importance/value and/or impact on the RAN's/cell's resource situation, and thereby, e.g., the RAN's choice of UE's and QoE configurations for which QoE reporting should be paused (e.g., in case of overload), may generally be denoted as “assistance information”.

The 3GPP specifications are formulated in a way that implies that the OAM is the entity that assembles a QoE measurement configuration and sends it to the RAN, that then configures one or more UEs. Nevertheless, the specifications overlook the fact that, in some scenarios, it is the QoE measurement consumer that assembles the QoE configuration, where, often, these consumers are not a part of the OAM system (e.g., the NWDAF and coming RAN automation functions). Alternatively, different consumers may at least provide input to OAM for determining the final QoE configuration to be sent to the RAN. Moreover, the OAM itself may consist of many different entities, which may even be distributed, many of which can be consumers of QoE measurements. It is, in fact, the consumer of the QoE information that orders a QoE measurement and likely assembles the QoE measurement configuration, or requests another entity to assemble the QoE configuration.

As briefly noted above, 3GPP has discussed a mechanism for the OAM system to configure the RAN with priorities according to which the QoE measurement reports will be delivered to the RAN, e.g., during RAN overload. In particular, the priority assigned to a QoE measurement configuration will determine whether the corresponding reporting from the UE will be paused during the overload. This scenario is referred to herein as “Scenario 1.”

Furthermore, again as noted above, 3GPP has agreed that, for certain services, e.g., applications delivered to the UE via the MBS communication service, the UE may conduct QoE measurements and store the QoE reports while in RRC_IDLE and RRC_INACTIVE states, provided that the application session is ongoing while the UE is in these states. After the UE comes back to RRC_CONNECTED state, the UE delivers the stored reports to the network. This scenario is herein referred to as “Scenario 2.”

Previously discussed solutions are OAM-centric, where the OAM system sets the reporting priorities. This approach, however, overlooks the fact that some consumers of QoE measurement reports, such as the NWDAF and forthcoming RAN automation functions, are not in the OAM system, which means that it is not always appropriate that the OAM system is the entity deciding on prioritization of reporting during an overload.

The solutions described herein address two scenarios:
Scenario 1: QoE reporting during RAN overload.
In this scenario, the RAN is provided with attributes/priorities, per QoE measurement configuration, according to which it may prioritize the QoE reporting of certain configurations during RAN overload. Herein, the reporting pertaining to attributes of higher priority is exempt from pausing during RAN overload.
Further granularity alternatives, in addition to per-QoE measurement configuration are possible, such as: per slice (e.g., per S-NSSAI or group of S-NSSAIs), per service types, per QoE measurement type, per area.
Scenario 2: Delivery of stored QoE reports when the UE returns from RRC_IDLE to RRC_CONNECTED state.
In this scenario, the UE is configured to conduct (or continue to conduct) QoE measurements for a session while in RRC_IDLE or RRC_INACTIVE state. In this case, the reports are stored at the UE, and delivered to the network when the UE comes back to RRC_CONNECTED state again. In the context of the present invention, the attributes/priorities assigned to each QoE measurement configuration may, e.g., pertain to which reports are delivered first, or which reports are discarded.

### Scenario 1: QoE Reporting During RAN Overload

The solution for Scenario 1 consists of the following steps, in various embodiments:
1. A network entity that is a consumer (to be) of QoE measurement(s) decides/determines to configure a QoE measurement job and/or assembles the QoE measurement configuration. This entity is herein referred to as the first network node. In addition to determining a QoE measurement configuration, the first network node also determines one or more attribute(s) of the measurement configuration, which should act as a guidance to the node that sends the QoE configuration to the UE, herein referred to as the second network node (e.g., a RAN node, where the first network node may send the configuration directly to the RAN node or via one or more other node(s)). The guidance is with respect to handling of QoE measurement reporting at overload at the second network node, where the reporting of certain QoE measurements may be, e.g., paused during the overload.
   a. An attribute (of the one or more attribute(s)) is assigned to each QoE measurement configuration and can be in form of one or more of the following:
      Explicitly indicated Priority.
      Explicitly indicated Relative Priority.
      An attribute other than a priority (as discussed below).
   b. In one variant the priority/attribute refers to pausing of QoE reporting during overload. In another variant it refers to resuming an already paused QoE reporting after the overload. In another variant, it refers to both pausing and resuming of the QoE reporting.
   c. Non-limiting examples of the first network node (i.e., the QoE measurement consumer) are:
      The OAM system or part thereof.
      An Element Manager
      A Network Management System
      A NWDAF.
      RAN automation functions.
      RAN nodes.
      A function in a RAN node deployed in split architecture (e.g., a gNB-CU-CP)
      O-RAN nodes, or part thereof.
      Split RAN nodes.
      A distributed part of the management system in a RAN or core network node.
      SON functions.
      Management functions.
      Assurance and analytics functions.
      Performance calculating functions.
      Fault handling management functions.
      A charging node.
      A node hosting the training function of an AI/ML model.
      A node hosting the data collection function of an AI/ML model.
      A node hosting the inference function of an AI/ML model.
      Any administrational entity.
      Orchestration functions in the RAN.
      Orchestration functions in the core network.
      Orchestration functions in the management system.

In one variant, a priority is an absolute priority, associated to a network node that is a consumer of the QoE measurements reports, or associated to a network node determining the QoE configuration (e.g., a higher priority can be associated to NWDAF compared to a Fault handling management functions)

In another variant, an attribute is a relative priority, that can be expressed as a relative weight, associated to one consumer of the QoE measurements reports, relative to another consumer of QoE measurements reports. The relative weight is used when priorities (e.g., the absolute priorities mentioned above) associated to two or more consumers are the same, to establish a second-level of differentiation between the consumers. In one sub-variant the two or more consumers are of the same type (e.g., two OAM nodes); in another sub-variant, the two or more consumers are of different types (e.g., a first consumer is an OAM node, and a second consumer is a RAN automation function). In one example of possible deployment, the same priority is configured for QoE configurations prepared by: 1) a first OAM node/entity managing a first set of RAN nodes that are not shared between network operators, and 2) a second OAM node/entity managing a second set of RAN nodes shared between two network operators. To differentiate the reporting towards the two OAM nodes, the relative weight configured by/associated to the first OAM node/entity is set to a higher value (or to a lower value) than the relative weight configured by/associated to the second OAM node/entity.

In another variant, different nodes/entities that can create QoE configurations and consume QoE reports can have different priorities by implementation or configuration (e.g., implementation or configuration in the RAN). With this variation, when one of these nodes/entities acts as the first network node and assigns priorities or relative weights and/or attribute(s) to QoE configurations, these priorities or relative weights and/or attribute(s) serve only to form a prioritization order between the QoE configurations created by the node/entity itself, or to form a prioritization order between the QoE configurations created by nodes/entities with equal priorities.

In another variant, a priority refers to a retention priority based on which a QoE measurement configuration can be kept at the expense of another one that is released during overload.

In another variant a priority refers to a vulnerability priority based on which a QoE measurement configuration can be released in order to keep another one during overload.

In another variant, the priority/attributes are the same (or different) if pertaining to QoE configurations to be used when the UE is in RRC_CONNECTED state and if pertaining to QoE configurations to be used when the UE is RRC_INACTIVE or RRC_IDLE state.

In another variant, priority/attributes are valid per network slice, and applied for all QoE configurations configured for the UE(s).

In another variant, priority/attributes are valid per service type, and applied for all QoE configurations configured for the UE(s).

In another variant, priority/attributes are valid per Radio Access Technology (RAT) and can be further differentiated per service type (e.g., based on the service type(s) supported in a given RAT. In another variant, priority/attributes are valid only in case of periodic QoE/RVQoE reporting.

In another variant, priority/attributes are valid only in case of one-time QoE/RVQoE reporting.

In one variant, priority/attributes are valid only for the first QoE/RVQoE report pertaining to a session of an application, or to a service type, or to a type of communication service, or to a service sub-type, or to a subservice type

In one variant, priority/attributes are valid only for the last QoE/RVQoE report pertaining to a session of an application, or to a service type, or to a type of communication service, or to a service sub-type, or to a subservice type

In another variant, priority/attributes are valid for QoE reports pertaining to a certain type of QoE measurement configuration. In one case, priority/attributes are only applicable to signaling-based QoE type of configuration. In another case, priority/attributes are only applicable to management based QoE type of configuration. In another case, priority/attributes are only applicable only to QoE configurations—either signaling based or management based—to be used by the UE when it is in certain RRC state or in one of certain RRC states (e.g., only in RRC_CONNECTED state, or only in RRC_INACTIVE state, or only in RRC_IDLE state, or only when in RRC_INACTIVE or in RRC_IDLE state). In yet another case, the priority/attributes are only applicable to a certain type of QoE configuration (e.g., signaling based QoE configuration or management based QoE configuration) when the UE is an a certain RRC state or in one of certain RRC states (i.e., both the QoE configuration type condition and the RRC state condition have to be fulfilled for the priority/attributes to apply).

In another variant, priority/attributes are applicable only for sending QoE reports comprising measurements collected by UE(s) when the UE(s) is(are) in a certain RRC state or in one of certain RRC states (e.g., only in RRC_CONNECTED state, or only in RRC_INACTIVE state, or only in RRC_IDLE state, or only when the UE is in RRC_INACTIVE or in RRC_IDLE state).

In another variant, priority/attributes are associated with UE mobility states. That is, a certain QoE configuration may have different priority/attributes depending on the UE's mobility state, e.g., one priority when the UE is in a high mobility state and another priority when the UE is in a medium/normal mobility state. The association between priority and UE mobility state may differ between different QoE configurations. The priorities may be used to determine, or select, which QoE configurations for which QoE reporting should be paused, e.g., during a situation of overload in a cell or a RAN node (e.g., a gNB or an eNB) or in a core network node (e.g., an AMF or an MME) to which the RAN node is connected. Note that this may mean that different UEs are treated differently in this respect. For example, if two UEs are configured with the same management based QoE configuration, and the UEs are in different mobility states, then a consequence of the difference in UE mobility state may be that QoE reporting is paused for the concerned management based QoE configuration for one of the UEs while the QoE reporting is not paused for the same management based QoE configuration for the other UE.

In another variant, priority/attributes are used to determine different reporting based on the UE mobility state. For example, two priorities are indicated (or can be derived from corresponding attributes pertaining to UE mobility states), a first priority to be used when reporting is resumed when overload is solved, for reporting of UEs in high-mobility, and a second priority to be used at resume when reporting is resumed when the overload situation has passed, for reporting of UEs in medium or normal mobility state.

In another variant, priority/attributes are used to determine different reporting based on area scope configuration. For example, two priorities are indicated (or can be derived from corresponding attributes pertaining to area scope), a first priority to be used when reporting is resumed when overload is solved, for reporting of UEs located within the area scope, and a second priority to be used at resume when reporting is resumed when the overload situation has passed, for reporting of UEs located outside the area scope.

In another variant, priority/attributes are used to determine different reporting based on the RAT where QoE measurements were collected. For example, two priorities are indicated, a first priority to be used when reporting is resumed when overload is solved and the QoE measurements were collected in E-UTRAN, and a second priority to be used when reporting is resumed when the overload is solved and the QoE measurements were collected in NG-RAN.

In another variant, priority/attributes are used to determine different reporting based on UE speed. For example, two priorities are indicated, a first priority to be used when reporting is resumed when overload is solved, for reporting of Ues at high speed, and a second priority to be used when reporting is resumed when the overload situation has passed, for reporting of Ues at low speed (or medium speed). The UE speed can be determined as “high”, “medium”, “low” (or similar categories) according to threshold configured by the network.

Another way that the area scope can be taken into account in the context of prioritizing QoE reporting is that a weight, or relative priority, is assigned, or used, depending on the size of the area scope. For example, a greater weight, or relative priority, could be assigned, or used, for QoE configurations with smaller area scope than for QoE configurations with larger area scope. For instance, if one QoE configuration has an area scope consisting of the present tracking area, while another QoE configuration (in the same UE or in a different UE) has the entire PLMN as its area scope, then the QoE configuration with the present tracking area as its area scope (i.e., the QoE configuration with the smaller area scope) may be assigned a greater weight, or relative priority, than the QoE configuration with the entire PLMN as its area scope. Hence, as a potential result, QoE reporting may be paused for the QoE configuration with the entire PLMN as its area scope, while QoE reporting is not paused for the QoE configuration with the present tracking area as its area scope. As one variant, these area scope size dependent weights, or relative priorities, may be delivered to a RAN node (which is responsible for pausing of QoE reporting when applicable) by the first node. As another variant, the RAN node (which is responsible for pausing of QoE reporting when applicable) may inherently know (e.g., from previous configuration or implementation) that QoE configurations, e.g., configurations with equal absolute priorities, should be ordered based on the sizes of their area scope, so that when the RAN node starts to pause QoE reporting, e.g., in an overload situation, the RAN node pauses QoE reporting for the QoE configuration(s) with the largest area scope first, and, if needed, continuous to pause QoE reporting for the QoE configuration(s) with the second largest area scope, and so on. A rationale for this kind of relative prioritization based on the size of the area scope may be that a QoE configuration with a large area scope may have more opportunities (e.g., more UEs in case of a management based QoE configuration) than a QoE configuration with a small area scope to generate QoE reports for a receiver (e.g., an MCE) to analyze and draw conclusions from.

In another variant, priority is not applied, or equivalently set to the lowest possible value, to a QoE configuration or to the reporting associated to a QoE configuration, when the QoE configuration refers to services delivered in broadcast, or in multicast.

In another variant, priority/attributes are applicable only for sending reports that are not aligned/to be aligned/correlated to radio measurements (e.g., MDT measurement). Or, on the contrary, a priority/attribute is applicable only for sending reports that are aligned/to be aligned/correlated to radio measurements (e.g., MDT measurement).

In another variant, the priority associated to one network node is absent (or null), indicating that the reporting of QoE reports ultimately intended for that network node (i.e., that network node is the consumer of the QoE reports) will be sent on a best-effort basis (e.g., when no QoE reporting has to be paused, e.g., because there is no overload in the cell or RAN node). For example, priority may not be defined for a QoE configuration whose corresponding QoE reports will be consumed by a Fault handling management function.

Slightly reformulated, in another variant (which in some cases is equivalent to the variant above, but which also may be different from the variant above), the priority associated with one network node is absent (or null), indicating that the reporting of QoE reports associated with QoE configuration(s) created by that network node will be sent on a best-effort basis (e.g., when no QoE reporting has to be paused, e.g., because there is no overload in the cell or RAN node).

In another variant, the priority is signaled together with one or more associated attributes determining the validity of the priority.
In a first sub-variant, the associated attribute(s) indicate(s) that the priority is applied upon reception of an overload indication (e.g., a start overload indication received by a RAN node from a CN node) and until reception of conclusion of overload (e.g., a stop overload indication received by a RAN node from a CN node).
In a second sub-variant, the associated attribute(s) indicate(s) a validity period for the priority. In one case (e.g., when reports received after a certain period of time will be discarded, or considered obsolete), the configured priority is only valid if (from the sender point of view) reports can be sent before the validity period expires. The start and end of the validity period can be implicitly or explicitly indicated. For example, in case of periodic reporting, the validity period can be assumed to start at the time the latest report has been sent (or at a time instant close to that), and the end of the validity period can be assumed as the start time plus a time interval specified by a reporting periodicity.
In a third sub-variant, a priority associated with a QoE configuration (to be applied to prioritization of QoE reporting to be paused and/or resumed) may have an associated validity time, optionally indicated by one or more attributes associated with the validity time and/or QoE configuration, and the starting point of this validity time is:
   the time when the QoE configuration is created,
   the time when the QoE configuration is received by a RAN node,
   the time when the QoE configuration is sent to a UE (e.g., the first UE in case of a management based QoE configuration)
   the time when the first QoE report associated with the QoE configuration is received by a RAN node, or
   an explicitly indicated time (e.g., a UTC), where the explicitly indicated start time may be one of the attributes indicating the validity time.

A rationale for having a validity time associated with a priority may be that the older the QoE configuration is, the more reported QoE measurement results it may potentially already have provided to the network, and following that reasoning, QoE reports for a younger QoE configuration (for which less QoE measurement results may be assumed to already have been reported) may typically, or generally, be more important for the network to receive.

In another variant, a priority associated with a QoE configuration may be time-dependent, such that it changes with the passing of time, e.g., with the age of the QoE configuration. For instance, a priority associated with a QoE configuration may decrease with time (e.g., reflecting the assumption that the older the QoE configuration is, the more QoE measurement results associated with that QoE configuration have been reported, implying that receiving further QoE reports associated with that QoE configuration may have less value for the network than receiving QoE reports associated with younger QoE configurations for which less QoE measurement results can be assumed to have been reported. The time-dependence of the priority may be indicated by one or more associated attributes. One example could be that an attribute indicates a linear time dependence (where a single attribute, the time dependence coefficient, would suffice to indicate the time dependence). In another example, multiple priorities are indicated, each with an explicitly or implicitly indicated (non-overlapping) time period during which it is to be applied. In one realization of this example, a list of priorities could be provided in a certain order, and each of these priorities is applied for a certain (explicitly indicated, previously configured, or standardized) time period, one after the other. The starting point of the counting of time for the time dependence is preferably the time of creation of the QoE configuration or the time when a RAN node receives the QoE configuration, but it may also be the time when the QoE configuration is sent to a UE (e.g., the first UE in case of a management, based QoE configuration), the time when the first QoE report associated with the QoE configuration is received by a RAN node, or an explicitly indicated time (e.g., a UTC).

In another variant, which potentially may be combined with any of the other variants, the first network node may update a priority previously associated with a QoE configuration. The update will be conveyed using the same means as the original priority. As an example, the first network node may decrease the priority associated with a QoE configuration when a significant amount of reported QoE measurement results have been received, forming a decent basis for analysis.

In another variant, at least two priorities are configured, each priority intended to be used for different levels of load, or some priorities are intended to be used when entering an overload, and other priorities are intended to be used when the overload situation has passed.
In one case, two values of priority are configured, a higher priority and a lower priority. The lower priority is to be used for load level between values X and Y, the higher priority is to be used for load levels above Y.
In another case, two values of priorities configured, a first priority to be used upon entering the overload situation, the second priority upon exiting the overload situation.

In another variant, priority/attributes concern QoE configurations targeting group of UEs (see below for definition).

In one case there can be different priority/attributes relevant for QoE configurations targeting group of UEs compared to QoE configurations targeting a specific UE. In another case, different priority/attributes can used among multiple QoE configurations targeting different group of UEs (e.g., the priority in the reporting from UEs in high mobility state, can be different compared to the priority in the reporting from UEs receiving data for the same application.

A “group of UEs” refers to UEs that have something in common and for which a network node is interested in configuring QoE measurements.

Non-limiting examples of a group of UEs include:
A group of UEs that receive the data for an application session using the same radio resource e.g., the exact same resources, and/or radio resources with the same priority at the network.
A group of UEs that receive data for the same application session, e.g., MBS, where the data can be delivered to the UEs using a common radio resource (e.g., PTM delivery mode for MBS) or separate radio resources for each UE (e.g., PTP delivery mode for MBS).
A group of UEs that travel together.
UEs configured with the same RAN-based Notification Area (RNA).
UEs in the same mobility state (or not in a certain mobility state).
UEs subject to group mobility.
UEs served by shared spectrum.
all (or part of) the UEs placed in a factory and connected to the same private network such as standalone non-public network or public network integrated non-public network,
UEs that are Fixed Wireless Terminals served by the same RAN node (where the RAN node in question may also serve other UEs).
UEs providing radio connectivity to machines or devices that perform one or more tasks in a coordinated manner.
UEs with certain capabilities, e.g., a certain set of UE capabilities.
UEs in the same multiconnectivity setup, e.g., NR-DC, EN-DC.
UEs that are in certain cell(s) or cell groups, which have the same MCG, the same SCG.
UEs that have a certain cell category, a certain allowed cell list (previously white list) or a certain cell category.
UEs under coverage of some specific SSB or CRI-RS beams.
UEs served by an IAB node or mobile IAB node.
UEs served by an IAB network, located a certain number of wireless hops from the IAB donor.
UEs connected to the network using the network-controlled relay.
UEs associated/served with/by certain set of network slices.

In one possible variant, priorities and/or attributes can be determined on the basis of QoE-related events of interest for the consumer/creator of the QoE measurement configuration. A QoE-related event happens in relation to QoE metrics, or RAN-visible QoE metrics, or RAN-visible QoE values, or a combination thereof. A QoE-related event is identified by a unique identifier (e.g., a value or a label used for an identity, such as a value for a QoE-Event-ID) and the definition of a QoE-related event can comprise:
an identifier of the QoE-related event (e.g., a QoE-Event-ID)
one or more parameters, conditions, and indications, among which
   parameters, conditions, and indications pertaining to QoE metrics, or part of QoE metrics, or combination thereof
   parameters, conditions, and indications pertaining to RVQoE metrics, or combination thereof
   parameters, conditions, and indications pertaining to RVQoE values, or combination thereof
   entering conditions for the event,
   leaving conditions for the event
   one of more thresholds (e.g., threshold for entering/leaving the event)
   one or more hysteresis (e.g., hysteresis for entering/leaving the event)
   duration of the event frequency of occurrence of the event (number of occurrences of the event in a given period of time)
   time-to-trigger
   reporting frequency from the UE.

In another variant, priority/attributes apply to a multi-connectivity scenario.

Any combination of the above is possible.
2. In a second step, the first network node sends the QoE measurement configuration to a second network node, together with the attribute(s).
   a. Case A: the first network node sends the QoE measurement configuration and the attribute(s) directly to the second network node (note that the second network node is the node that configures the UE with the QoE measurement configuration and which may subsequently pause and resume QoE reporting for the QoE measurement reporting configured in the UE).
   b. Case B: the first network node sends the QoE measurement configuration and the attribute(s) to an entity that (with or without some intermediate processing) sends the QoE measurement configuration and the attribute(s) to the second network node. This entity is referred to as the third network node.
      In one variant, there may exist one or more additional network nodes that receive and forward a QoE configuration and the attribute(s) towards the second network node (e.g., in case of signaling based QoE for NR, an AMF node can act as additional network node between the creator of the QoE configuration (the first network node) and a gNB (the second network node).
3. In a third step, if the QoE measurement configuration and its associated priority and/or attribute(s) are received by the third network node (Case B), the third network node executes one or more of the following actions:
   a. In one option, pertaining to the case where the attribute(s) of the measurement configuration comprise(s) a priority, the third network node forwards the configuration and the priority to the second network node. The third network node may or may not amend the QoE measurement configuration, but does not alter the indicated priority. In other words, the third network node blindly follows the priority set by the node that created the QoE measurement configuration and/or the consumer of QoE reports.
   b. In another option, pertaining to the case where the attribute(s) of the measurement configuration comprise(s) a priority, the third network node executes the sorting of priorities of different configurations pertaining to the same second network node, and, optionally, recalculates the priority.
   c. In another option, pertaining to the case where the attribute(s) of the measurement configuration comprise(s) attribute(s) other than a priority, the third network node calculates the priority.
      The priority can be calculated based on different types of attributes, such as:
         QoE report consumer type. For example:
         a. Assurance and analytics function is assigned priority 1.
         b. Management function that calculates KPIs is assigned priority 2.
         c. Customer care center is assigned priority 3 etc.
         Application layer service type that the QoE configuration applies to.
         Area scope associated with the QoE configuration.
         Slice scope associated with the QoE configuration.
         Type of QoE configuration (e.g., signaling based or management based).
      In some variants, the attribute(s) is(are) just one of the inputs for determining the priority.
      The algorithm for calculating the priority, or the mapping between the attribute and the priority may be:
         Hard coded.
         Set by the operator.
         Configured.
         Hardcoded, configured or set by the operator, and then refined using AI/ML functionality.
   In one variant, the configured and the applied priorities can be different, and the applied priority varies with the load. For instance, a priority of 10 is configured for a QoE measurement, and a RAN node detects the overload at 99% (e.g., unitless). In this example it is assumed that a lower priority corresponds to a priority with lower value. At a first instance, the load is 95% and the RAN determines (according to instruction received from the first network node, or according to configuration or standard specification) to apply a priority of 5. If the load increases and reaches 98%, the RAN uses a priority of 8. If the load still increases and reaches 99% or above, the RAN uses the configured priority of 10.
   Some further interaction the third network node may have with other nodes/entities may include one ore more of the following:
      When the first network node creates a QoE configuration, the first network node requests the third network node to provide a priority (or relative weight), and/or attribute(s), for the QoE configuration, and the third network node returns such a priority or relative weight and/or attribute(s) to the first network node.
      When the first network node has created a QoE configuration, it sends the QoE configuration to the third network node, which assigns a priority (or relative weight) and/or attribute(s) to the QoE configuration and forwards the QoE configuration and the priority or relative weight and/or attribute(s) to the second network node.
      The third network node proactively assigns priorities (and relative weights if applicable), and/or possibly attribute(s), to the various nodes/entities that are capable of creating QoE configurations (and consuming QoE measurement reports generated in accordance with the QoE configurations) and sends these priorities (or relative weights) and/or possibly attribute(s) to the concerned nodes/entities. A node/entity which receives a priority (or relative weight) and/or attribute(s) in this way subsequently assigns this priority (or relative weight) and/or attribute(s) to the QoE configurations it subsequently creates. Here, the third network node may e.g., be an OAM node or entity.
      The third network node proactively assigns priorities (and relative weights if applicable), and/or possibly attribute(s), to the various nodes/entities that are capable of creating QoE configurations (and consuming QoE measurement reports generated in accordance with the QoE configurations), and sends—to all (or some) RAN nodes (gNBs or eNBs) in the network—information about the assigned priorities (and relative weights if applicable) and/or attribute(s) together with indications of the nodes/entities they are assigned to. Here, the third network node may e.g., be an OAM node or entity.
   If the QoE measurement configuration and its attribute are received by the second network node without an intermediate third network node (Case A—the second network node is the node which sends the QoE configuration to the UE(s), and which may subsequently instruct UE(s) to pause QoE reporting for the QoE measurement configuration), the actions described above in this step for the third network node may in some embodiments be executed by the second network node.
4. In a fourth step, applicable (along with step 3) only to Case B, the third network node sends the QoE configuration and the corresponding priority (and possibly also associated attribute(s)) to the second network node. Alternatively, the third network node does not calculate the priority based on the attributes received from the first network node (as described as one of the options in step 3 above), but instead forwards the attribute(s) to the second network node, and the second network node determines the priority based on the attribute(s). Note that, in Case A, the second network node has already received the QoE measurement configuration and the attribute(s) directly from the first network node.
5. In a fifth step, the second network node configures one or more UEs with QoE measurements by sending them the QoE measurement configuration. Neither the reporting priority nor the attributes are sent to the UEs. Alternatively, the priority and/or at least part of the attributes of QoE reporting pertaining to a QoE measurement configuration are sent to the UE together with the QoE measurement configuration received from the first network node or the third network node.
6. In a sixth step, when an overload in the second network node occurs (or the load in the second network node is close to overload, e.g., is equal to or greater than an overload level minus a threshold), based on the received priority and/or attribute(s), the second network node determines for which QoE measurement configuration(s) the corresponding QoE reporting from the UE(s) will be paused. The UE(s) which is(are) configured with at least one of the determined QoE measurement configuration(s) is(are) instructed to pause sending of QoE measurement reports pertaining to the determined QoE measurement configuration(s) (or a subset of the determined QoE measurement configuration(s)). Alternatively, if the priority and/or the attribute(s) of QoE reporting pertaining to a QoE measurement configuration are sent to the UE together with the QoE measurement configuration, the UE pauses QoE reporting in accordance with the received priority and/or attribute(s).
   As mentioned earlier, the priority/attribute(s) refers to pausing of reporting during overload. In another variant it refers to resuming an already paused reporting after the overload. In another variant, it refers to both pausing and resuming of the reporting.

### Additional or Alternative Embodiments

According to the 3GPP release 17 specifications, a UE AS should store QoE reports it receives from the application layer when these QoE reports are subject to a pause reporting instruction the UE AS has received from the RAN. For the purpose of storing such pending QoE reports, the 3GPP release 17 specifications stipulate that the UE AS should have a minimum of 64 KB memory available. This memory/storage may also have a UE implementation-specific upper limit, which may be greater than or equal to 64 KB. If, during a situation where at least some QoE reporting (i.e., QoE reporting for one or more QoE configuration(s) (each indicated by its associated measConfigAppLayerId parameter)) has been paused by the RAN, the UE AS receives (from the application layer) QoE reports subject to the reporting pausing, whose accumulated size exceeds the upper limit of the memory/storage for pending QoE reports, the UE AS will discard QoE report(s) for which there is no room in the memory/storage for pending QoE reports.

When such a situation arises, it may be preferable that the network can control, or impact, which of the pending QoE reports the UE AS discards. To this end, the priority and/or attribute(s) can be sent from the second network node to the UE AS to be (at least part of) the basis for selection of pending QoE reports to be discarded in case the memory for storing of pending QoE reports in the UE AS is filled up (and QoE reports compete for memory that is insufficient for storing all the pending QoE reports).

The priority and/or attribute(s) may e.g., be sent in an AppLayerConfig IE in an RRCReconfiguration message in NR.

### Additional Embodiments for Multi-Connectivity Operations

The solution as described above can be extended to multi-connectivity scenarios, wherein a UE is configured for multi-connectivity operation (e.g., one of the options of Multi-Radio Dual Connectivity such as NR-DC).

In one variant, a possible extension relates to providing-together with or as part of QoE/RVQoE configuration-priority and/or attributes that implicitly or explicitly indicate to a UE to switch the sending of QoE/RVQoE reports corresponding to the QoE configurations to which the priority/attributes pertain to, towards one network node instead of another, when an overload situation has started or is about to start at a network node, or an overload situation has passed for a network node.
In one case, priority and/or attributes indicate that, in case a UE is configured for MR-DC operation comprising a first RAN node and one (or more) other RAN nodes, the first RAN node, upon determining an overload, sends an indication to the UE, indicating to switch/continue the QoE/RVQoE reporting corresponding to the QoE configurations to which the priority/attributes pertain to, towards another one of the RAN nodes comprised in MR-DC operation.
In one case, priority and/or attributes indicate that, in case a UE is configured for MR-DC operation comprising a first RAN node and one (or more) other RAN nodes, the first RAN node, upon determining an overload, sends an indication to one of the other RAN nodes, requesting the one of the other RAN nodes to indicate to the UE to switch the QoE/RVQoE reporting corresponding to the QoE configurations to which the priority/attributes pertain to towards the other RAN node.
In another case, priority and/or attributes indicate that, in case a UE is configured for MR-DC operation comprising a first RAN node and one (or more) other RAN nodes, and the load of the first RAN node is high but overload has not started yet, the first RAN node sends an indication to the UE, indicating to switch/continue the QoE/RVQoE reporting corresponding to the QoE configurations to which the priority/attributes pertain to towards another one of the RAN nodes comprised in MR-DC operation.
In another case, priority and/or attributes indicate that, in case a UE is configured for MR-DC operation comprising a first RAN node and one (or more) other RAN nodes, and the load of the first RAN node is high but overload has not started yet, the first RAN node, upon determining an overload, sends an indication to one of the other RAN nodes, requesting the one of the other RAN nodes to indicate to the UE to switch the QoE/RVQoE reporting corresponding to the QoE configurations to which the priority/attributes pertain to, towards the other RAN node.
In another case, priority and/or attributes indicate that, in case a UE is configured for MR-DC operation comprising a first RAN node and one (or more) other RAN nodes, and the overload of the first RAN has passed, the first RAN node sends an indication to the UE, indicating to switch the QoE/RVQoE reporting corresponding to the QoE configurations to which the priority/attributes pertain to, towards the first RAN node
In another case, priority and/or attributes indicate that, in case a UE is configured for MR-DC operation comprising a first RAN node and one (or more) other RAN nodes, and the overload of the first RAN has passed, the first RAN node sends an indication to one of the other RAN nodes, requesting the one of the other RAN nodes to indicate to the UE to switch the QoE/RVQoE reporting corresponding to the QoE configurations to which the priority/attributes pertain to, towards the first RAN node.

In another variant, a possible extension relates to providing-together with or as part of QoE configuration-priority and/or attributes that implicitly or explicitly indicate to a first network node comprised in multi-connectivity operation a ranking to be used by the first network node to fetch QOE/RVQoE reports corresponding to the QoE configurations to which the priority/attributes pertain to, and received by the another network node when overload is present at the first network node.

In another variant concerning multi-connectivity operation (e.g., MR-DC operation), priorities/attributes can be provided to indicate a preferred/recommended/suggested order (ranking) according to which one of the RAN nodes comprised in multi-connectivity can transfer (or cannot transfer) QoE/RVQoE reports corresponding to the QoE configurations to which the priority/attributes pertain to, to another RAN node comprised in multi-connectivity when overload is present.

In another variant concerning multi-connectivity operation (e.g., MR-DC operation), in relation to the role of a RAN node within the multi-connectivity operation, priorities/attributes can be provided to indicate which RAN node (in terms of role, i.e., an MN node or an SN node) is the one in charge of pausing QoE/RVQoE reporting when overload is present/triggered and/or in charge of collecting the QoE/RVQoE reports when overload is not present/passed.

In another variant concerning multi-connectivity operation (e.g., MR-DC operation), priorities/attributes can be provided to indicate a preferred/recommended/suggested order (ranking) according to which a RAN node comprised in multi-connectivity has to provide a first network node (consumer)—possibly via one or more other network nodes-, the QoE/RVQoE reports. In one sub-variant, the priorities/attributes (or the corresponding ranking) are (is) sent to all RAN nodes comprised in multi-connectivity. In another sub-variant, the priorities/attributes (or the corresponding ranking) are (is) sent only to an MN node. In another sub-variant, the priorities/attributes (or the corresponding ranking) are (is) sent only to an SN node.

In another variant concerning multi-connectivity operation (e.g., MR-DC operation), priorities/attributes can be provided to indicate a preferred/recommended/suggested order (ranking) to be used only if RAN overload is ongoing or to be used only when start of RAN overload is detected, or to be used only when end of RAN overload is detected, according to which a RAN node comprised in multi-connectivity has to provide a first network node (consumer)—possibly via one or more other network nodes—, the QoE/RVQoE reports. In one sub-variant, the priorities/attributes (or the corresponding ranking) are (is) sent to all RAN nodes comprised in multi-connectivity operation. In another sub-variant, the priorities/attributes (or the corresponding ranking) are (is) sent only to an MN node. In another sub-variant, the priorities/attributes (or the corresponding ranking) are (is) sent only to an SN node.

In another variant concerning multi-connectivity operation (e.g., MR-DC operation), priorities/attributes apply only under the condition that one of the RAN nodes comprised in multi-connectivity operation can provide indications, either to the first network node (consumer) or some other network nodes, indicating the alignment/correlation between the QoE/RVQoE measurements and radio related measurements and/or radio related information.

In another variant, concerning multi-connectivity operation, the priority of QoE reporting configured or derived in case of multi-connectivity operation takes precedence over the priority of QoE reporting configured or derived in case of single connectivity. For example, a first priority pertaining to QoE/RVQoE reporting in case of multi-connectivity takes precedence (overrides) over a second priority pertaining to QoE/RVQoE reporting in case of single connectivity. The opposite scenario is also possible.

In another variant, the priority of QoE reporting configured or derived in case of multi-connectivity operation is the same as the priority of QoE reporting configured or derived in case of single connectivity.

Any combination of the above is possible.

As mentioned above, previous solutions only take one aspect (or one stakeholder's interest) into account when the priorities are set, namely the importance or value of the data expected in the QoE reports to the consumers of the reports. With the newer solutions discussed herein, another aspect (or another stakeholder's interest) is also taken into account, namely the RAN's interest, which concerns mainly the impact of the QoE reporting on the resource situation in the cell and/or RAN node, e.g., the load. This is especially true in a situation of overload or close to overload. The choice of UE's and QoE configurations for which QoE reporting are paused, e.g., in case of overload, may then become a RAN decision based on priorities/attributes reflecting the importance/value of the QoE report content and the expected impact on the RAN's/cell's resource situation, where the latter may be reflected by some of the additional attributes listed below. Note that these two aspects may sometimes be contradictory. For example, if a QoE configuration is expected to result in very valuable QoE measurement data being reported, while this reporting is also expected to have a significant negative impact on the resource situation in the cell (or in the RAN node), then the decision of for which UE and QoE configuration the QoE reporting should be paused becomes a tradeoff between the two aspects.

Priorities or attributes of various kind with the purpose of impacting the RAN's assessment of expected QoE reporting, e.g., in terms of importance/value and/or impact on the RAN's/cell's resource situation, and thereby e.g., the RAN's choice of UE's and QoE configurations for which QoE reporting should be paused (e.g., in case of overload), may generally be denoted as “assistance information”.

With respect to the above, some additional attributes may be defined. Any one or more of these may be considered by the RAN node in determining for which QoE configuration the QoE reporting should be paused:
The loop cycle of the consumer.
   Loop cycle equals the time it takes for the consumer to collect the report, to analyze it, and to take an action based on it. It can be expected that a centralized consumer has a longer loop-cycle compared to a distributed (e.g., local) consumer. It can also be assumed that a longer “loop cycle” means that the corresponding QoE reports can wait more time before being delivered. So, a possibility could be that the “assistance information” informs the RAN about which “consumer type” wants to receive the QoE reports, and the RAN can take this into account. Another possibility is that the assistance information includes one or more attribute(s) more explicitly representing the loop cycle, e.g., an estimate of the loop cycle, or a unit-less number reflecting the relative loop-cycle length/duration (e.g., a higher value means a longer relative loop-cycle). Obviously, the RAN should avoid pausing the reporting for the consumers with shorter loop cycles.
      The loop cycle can be indicated in a generic manner, e.g., “long”, “short”, or “seconds”, “minutes”, “hours”, “days”, “weeks”, “longer than 1 second”, “shorter than 1 second”, “longer than 1 minute”, “shorter than 1 minute”, “longer than 1 hour”, “shorter than 1 hour”, etc.
      The loop cycle can be indicated in an indirect way, e.g., as an indication of “scale” or “order of magnitude”. Such indication can reflect for example, the number of objects (such: cells, network nodes, Tracking Areas, etc.) from which the consumer can receive/is receiving QoE reports and towards which the consumer (or another entity, based on the QoE reports collected by the consumer) takes action.
      The loop cycle can be indicate in terms of consumer type (as described above).
      As described above, the loop cycle indication can be a unit-less number reflecting the relative loop-cycle length/duration (e.g., a higher value means a longer relative loop-cycle).
Reporting characteristics expected from a certain consumer, which can be provided to the RAN in advance (i.e., before the first QoE report is received), typically provided to the RAN together with an associated QoE configuration.
   Some examples of attributes (which may be provided separately or in various combinations) are:
      Reporting periodicity
         As one option, this includes the possibility to indicate that “a QoE report will be sent only at the end of the application session the QoE measurements are performed on”.
         As another option, the reporting periodicity attribute is applicable only when periodic QoE reporting is configured by the QoE configuration.
      An indication of whether periodic QoE reporting or QoE reporting only at the end of each session is configured.
      Report size, e.g., the typical or average expected size of a QoE report.
      Throughput incurred by QoE reports.
      Number or QoE reports expected to be sent during per session.
      Average duration of a session.
      Expected frequency of sessions (e.g., frequency of session initiations).
      Expected minimum/maximum/average number of QoE reports per time unit (e.g., seconds, minutes, hours, etc),
      Expected minimum/maximum/average number of QoE reports per user or per UE.
      Expected minimum/maximum/average number of QoE reports per service type
      Expected minimum/maximum/average time between subsequent receptions of QoE reports (inflow, from consumer point of view)
      Expected amount of QoE report data generated per session.
      Expected amount of QoE report data generated per time unit during an ongoing session.
      Expected amount of QoE report data generated per time unit (on average) including both periods of ongoing sessions and periods when no sessions are ongoing.
Properties of the distribution of the QoE configuration.
   The number of RAN node(s) the QoE configuration has been and/or will be sent to (applicable for management-based QoE configurations). (The rationale for providing this information is that the more RAN nodes the QoE configuration is sent to, the less impact on the overall analysis of the reported QoE measurement data can pausing of the QoE reporting in a single UE be assumed to have.)
Scope of interest for the consumer.
   The scope of interest can be the same as the area scope, or other scope parameters, such as a list of network slices, a PLMN, a RAT, a type of spectrum (licensed or unlicensed/shared) a Tracking Area (e.g., indicated as a TAI or a TAC), a list of Tracking Areas, a list of equivalent PLMNs, a list of service types.
Target/goal of the consumer
   The target/goal of the consumer can be a target for an average/minimum/maximum value of at least one QoE metric (or RVQoE metric), where the target indicates something to strive for, e.g., that potential actions performed as a result of analysis of the reported QoE measurement data may have as a goal to achieve. A target can be: a general target (that considers all the QoE reports collected by the consumer), or a more specific target, associated/defined for a subset of QoE reports collected by the consumer which pertain to a certain “scope of interest” for the consumer.
   A target can be expressed for instance as: a “percentage of completion”, an “offset/deviation from the target”.
Other tasks at the consumer
   The consumer can express a priority or attribute in relation to its interest in receiving QoE reports due to a need to manage/consider the content of QoE reports in combination with other information. A prominent case can be the need to align radio related information/measurements (such as MDT measurements) and QoE measurements. There is a scenario, for example, where a UE reconnecting from RRC_INACTIVE or RRC_IDLE to RRC_CONNECTED state informs the network of the availability of MDT measurements collected while the UE was in RRC_IDLE and/or RRC_INACTIVE state. Upon request from the network to obtain such MDT measurements, the UE can send, together with MDT measurements, also QoE reports containing measurements collected while the UE was in RRC_IDLE and/or RRC_INACTIVE state. The sending of QoE reports is done in a way that reflects/takes into account the priority/attributes described herein.
Additional aspects the RAN may take into account, e.g., when deciding for which UE(s) and QoE configuration(s) QoE reporting should be paused:
   The RAN node may take into account the number of UEs it has already configured with a certain management-based QoE configuration (this may be regarded as an assistance information attribute generated by the RAN node itself). For instance, a RAN node may choose to pause QoE reporting from a UE for a QoE configuration which many UEs have been configured with while refraining from pausing QoE reporting from a UE for a QoE configuration which fewer UEs have been configured with. The rationale for such a choice may be that pausing QoE reporting for a QoE configuration which many UEs have been configured with may be assumed to have less negative impact from a QoE management or QoE consumer perspective (e.g., less negative impact on the analysis of the reported QoE measurement data) than pausing of QoE reporting from a UE for a QoE configuration which few UEs have been configured with.
   The RAN node may take into account the number of QoE reports it has already received and forwarded to the MCE for a certain QoE configuration (this may be regarded as an assistance information attribute generated by the RAN node itself). For instance, the more QoE reports already received and forwarded for a QoE configuration, the less negative impact may be expected from pausing of the QoE reporting for this QoE configuration.
   The RAN node may take into account the amount of QoE report data it has already received and forwarded to the MCE for a certain QoE configuration (this may be regarded as an assistance information attribute generated by the RAN node itself). For instance, the more QoE report data already received and forwarded for a QoE configuration, the less negative impact may be expected from pausing of the QoE reporting for this QoE configuration.
   The RAN node may take into account the number of complete application sessions for which QoE reports have already been received and forwarded to the MCE for a certain QoE configuration (this may be regarded as an assistance information attribute generated by the RAN node itself). For instance, the more sessions for which QoE reports have already been received and forwarded to the MCE, the less negative impact may be expected from pausing of the QoE reporting for this QoE configuration.
   The RAN node may take into account the accumulated duration of the application sessions for which QoE reports have already been received and forwarded to the MCE for a certain QoE configuration (this may be regarded as an assistance information attribute generated by the RAN node itself). For instance, the more accumulated application session duration for which QoE reports have already been received and forwarded to the MCE, the less negative impact may be expected from pausing of the QoE reporting for this QoE configuration.
   The RAN node may take into account whether a session (i.e., an application session with an associated QoE measurement session) is ongoing (e.g., based on receptions of session start/stop indications as indicated by the appLayerSessionStatus-r17 IE in a MeasurementReportAppLayer RRC messages). This may be regarded as an assistance information attribute generated by the RAN node itself. For instance, if the RAN, when selecting UEs and QoE configurations for which QoE reporting should be paused, selects UEs and QoE configurations for which sessions are ongoing, the RAN node can achieve a certain impact (i.e. reduction) on the load caused by the QoE reporting through pausing the QoE reporting for fewer UEs and QoE configurations than if the session ongoing status were not to be taken into account.

The attributes described herein can be combined in the sense that the assistance information provided to RAN can be implemented as a unique value of an Information Element, or as a set (array) of values (for example in the form of a Bitmap) which provides the RAN with multiple attributes which the RAN and/or the UE can take into account.

Scenario 2: Delivering of QoE Reports when the UE Returns from RRC_IDLE or RRC_INACTIVE to RRC_CONNECTED State

As explained above, in this scenario, the UE is configured to conduct (or continue to conduct) QoE measurements for a session while in RRC_IDLE or RRC_INACTIVE state. In this case, the reports are stored at the UE, and delivered to the network when the QoE comes back to RRC_CONNECTED state again.

The general steps for Scenario 2 may be as follows:
1. A QoE configuration is assembled, including the attributes/priorities (i.e. assistance information) as described above and optionally also including, when relevant, the additional attributes described immediately above. Alternatively, the attributes/priorities pertaining to the QoE measurement configuration may be a supplement to the configuration (i.e., not a part of it).
2. The QoE configuration is delivered to the RAN, either directly from the OAM (in case of management-based QoE configuration) or via the AMF in case of signaling based QoE configuration. The configuration applies to measurements to be conducted when the UE is in RRC_IDLE and/or RRC_INACTIVE state (possibly in addition to RRC_CONNECTED state).
3. The QoE measurement configuration is sent to the UE.
   a. In one variant, the assistance information (i.e., the attributes/priorities) is sent to the UE. In one variant, the attributes/priorities are kept in the UE AS. In another variant, the attributes/priorities are forwarded to the UE application layer, e.g., conveyed using an AT-command specified in 3GPP TS 27.007 version 18.1.0.
   b. In another variant the assistance information (i.e., the attributes/priorities) is kept at the RAN.
   c. In both above variants, the RAN may modify the attributes/priorities with respect to their original form, i.e., with respect to the attributes/priorities received from the OAM.
   d. In yet another variant, the attributes/priorities are “hard coded” in the specification, e.g., in the form of instructions in procedure text. The specification may e.g., instruct the UE to transmit certain QoE reports first, e.g., QoE reports of a certain service type, related to certain network slice(s), newest QoE reports first, oldest QoE reports first, etc.
   e. In yet another variant, the attributes/priorities are not sent to the UE but may be up to UE implementation.
4. The application session at the UE is started, together with the QoE measurements. The UE's transition from RRC_CONNECTED to RRC_IDLE or RRC_INACTIVE state may occur before or after the session is started. While in RRC_IDLE or RRC_INACTIVE state, the UE conducts the measurements, and stores the generated QoE reports.
5. The UE returns from RRC_IDLE or RRC_INACTIVE to RRC_CONNECTED state.
   a. In one variant, pertaining to the case where the attributes/priorities have been sent to the UE previously, the UE handles the stored QoE reports, as stipulated by the priorities/attributes.
   b. In another variant, pertaining to the case where the attributes/priorities have not been sent to the UE, but were instead stored at the RAN, the UE indicates QoE report availability (either a general availability—e.g., a flag indicating that QoE reports are available—or an availability per QoE configuration), and the RAN provides the related attributes/priorities to the UE and the UE acts accordingly.
   c. In another variant, pertaining to the case where the attributes/priorities have not been sent to the UE, but were instead stored at the RAN, the UE may send the QoE reports to the RAN node and the RAN node applies the attributes/priorities upon forwarding the reports to the MCE.
   d. In another variant, pertaining to the case where the attributes/priorities are “hard coded” in the specification, the UE sends the QoE reports to the RAN node according to the specified instructions.
   e. In another variant, the UE may send the QoE reports to the RAN node according to UE implementation. The UE implementation may comprise similar attributes/priorities as listed herein as options to be specified.

In the context of the present invention, based on the attributes/priorities defined above and assigned for the QoE/RVQoE reporting, for instance to each QoE measurement configuration, the UE may consider and decide the following related to QoE/RVQoE reporting in Scenario 2:
How many and which report(s) is(are) delivered first when the UE returns from RRC_IDLE and/or RRC_INACTIVE to RRC_CONNECTED state.
How many and which reports are discarded.
How many and which report(s) can be transmitted together in a single transmission over the air interface to the RAN, e.g., in a single MeasurementReportAppLayer RRC message or a single UEInformationResponse RRC message.
How long it is possible to wait before sending a QoE/RVQoE report before determining that the report should/can be discarded.
Build or maintain a list (or queue) of QoE/RVQoE reports to be transmitted from the UE AS over the air interface to the RAN.
Establish an order of sending for the buffered/stored QoE/RVQoE report.
Build or maintain a list (or queue) of QoE/RVQoE reports to be transmitted from the UE application layer to the UE AS.

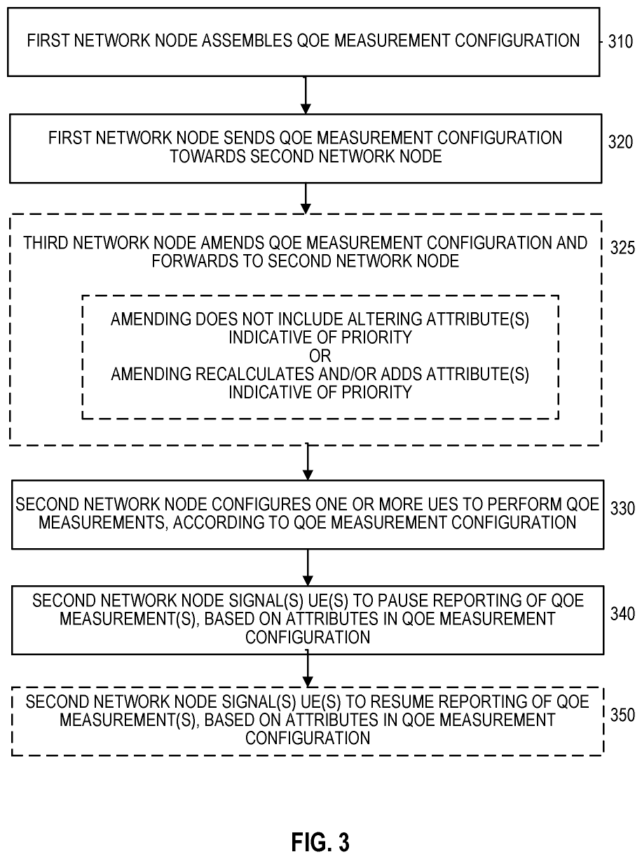

In view of the detailed examples and illustrations provided above, it will be appreciated that FIG. 3 is a process flow diagram illustrating an example method, in a network, for handling quality-of-experience (QoE) measurement reporting. The illustrated method is intended to be a generalization of and to encompass all of the various techniques described above. Thus, where the terminology used to describe the method of FIG. 3 and its variants differs from that used above, the former should be understood to be a generalization of and/or to encompass the latter. Likewise, the discussion below does not address all of the possible variants and details of the illustrated method—all of the variants and details provided above may be applied to various embodiments of the method shown in the figure.

As shown at block 310, the method comprises a first step in which a first network node assembles a QoE measurement configuration, the QoE measurement configuration comprising one or more attributes indicative of at least one absolute priority or relative priority for one or more QoE measurements. As shown at block 320, the first network node sends the QoE measurement configuration towards a second network node. As shown at block 330, the second network node configures one or more user equipments (UEs) to perform QoE measurements, based on the QoE measurement configuration.

As shown at block 340, the second network node, responsive to at least a first load condition in or associated with the second network node, signals one or more of the UEs to pause reporting of one or more of the QoE measurements, based on the one or more attributes. The first load condition may be an overload condition or a loading near to an overload condition, as was discussed above. In some embodiments or instances, the second network node signals one or more of the UEs to pause reporting of the one or more of the QoE measurements based further on which of two or more radio access technologies (RATs) the at least one of the UEs is using, and/or based on a speed of each of the at least one of the UEs. In some of these and in some other embodiments, the second network node signals one or more of the UEs to pause reporting of the one or more of the QoE measurements based on a reporting frequency for each of the at least one of the UEs. In some of these and in still other embodiments or instances, the second network node signals one or more of the UEs to pause reporting of the one or more of the QoE measurements based on any one or more of the additional attributes discussed above, such as a loop cycle of a consumer of the QoE measurements for the UE, reporting periodicity for the QoE measurements, an indication of whether periodic QOE measurement reporting or QoE measurement reporting at the end of a session is expected for the UE, an expected report size for the QoE measurements for the UE, number of QoE reports expected to be sent during a session, average duration of a session, expected frequency of sessions, expected number of QoE reports per time for the consumer of the QoE measurements, expected number of QoE reports per UE for the consumer of the QoE measurements, a number or distribution of radio access network (RAN) nodes to which the consumer has provided QoE configuration, a number of UEs the second network node has configured QoE reporting and/or with a given QoE configuration, a number of QoE measurement reports the second network node has already forwarded for a certain QoE configuration, and a number of complete application sessions for which QoE reports have been received and reported. Several other examples were discussed above.

In some embodiments or instances, the second network, responsive to at least a second load condition in or associated with the second network node, signals one or more of the UEs to resume reporting of one or more of the QoE measurements, based on the one or more attributes. This is shown at block 350, which is illustrated with a dashed outline to indicate that it need not appear in every embodiment or instance of the illustrated method. This second load condition may be the end of an overload condition, for example, or a loading that falls below some threshold loading condition near to an overload condition, again as was discussed above.

In some embodiments or instances, the first network node is a consumer of QoE measurement reports and is outside of any Operations and Management (OAM) system in or associated with the network.

In some embodiments or instances, the second network node is a Radio Access Network (RAN) node, and configuring the one or more UEs to perform QoE measurements comprises delivering all or part of the QoE measurement configuration to each of the one or more UEs. In some of these embodiments or instances, delivering all or part of the QoE measurement to each of the one or more UEs comprises omitting at least one of the one or more attributes. In some embodiments or instances, delivering all or part of the QoE measurement to each of the one or more UEs comprises including one or more attributes that implicitly or explicitly indicate to the UE to which network node, of multiple network nodes to which the UE is connected, one or more QoE measurements are to be reported.

In some embodiments or instances, sending the QoE measurement configuration towards the second network comprises sending the QoE measurement configuration towards a third network node, for subsequent forwarding towards the second network node. In some of these embodiments or instances, the third network node amends the QoE measurement configuration before forwarding towards the second network node, without altering the one or more attributes indicative of the at least one absolute priority or relative priority for the one or more QoE measurements. This is shown as one of the alternatives in block 325. In others of these embodiments or instances, the third network node amends the QoE measurement configuration before forwarding towards the second network node, where this amending comprises altering the one or more attributes indicative of the at least one absolute priority or relative priority for the one or more QoE measurements. In some of these latter embodiments or instances, the third network node alters the one or more attributes indicative of the at least one absolute priority or relative priority for the one or more QoE measurements by (a) sorting priorities and/or priority-related attributes for multiple QoE measurement configurations, including the QoE measurement configuration, and recalculating the one or more attributes indicative of the at least one absolute priority or relative priority for the one or more QoE measurements, based on said sorting, and/or adding an additional one or more attributes indicative of the at least one absolute priority or relative priority for the one or more QoE measurements, based on said sorting, and (b) including the altered one or more attributes and/or the additional one or more attributes in the QoE measurement configuration before forwarding towards the second network node. This is shown as another alternative in block 325.

The method shown in FIG. 3 and discussed above includes steps and operations carried out by at least first and second network nodes, and, in some embodiments or instances, additional steps and operations carried out by a third network node and/or a user equipment. It should be understood that separate process flow diagrams can be constructed and separate methods described for each of these nodes, with each focused on those steps and operations carried out by the corresponding node.

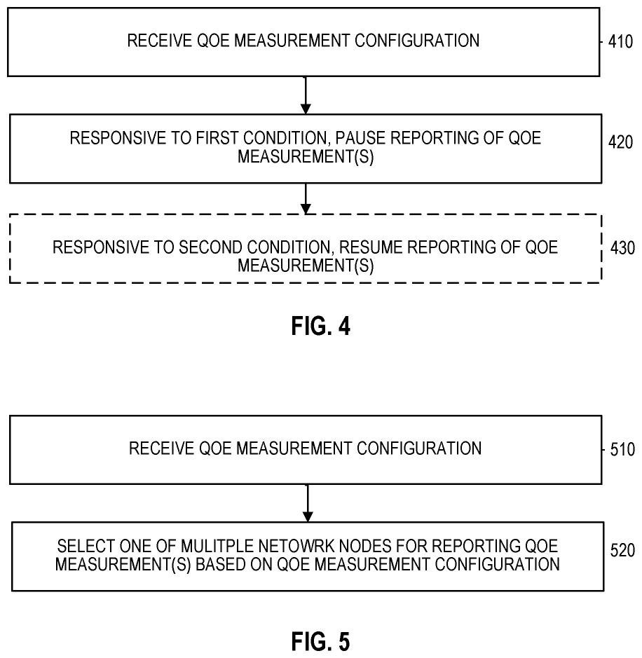

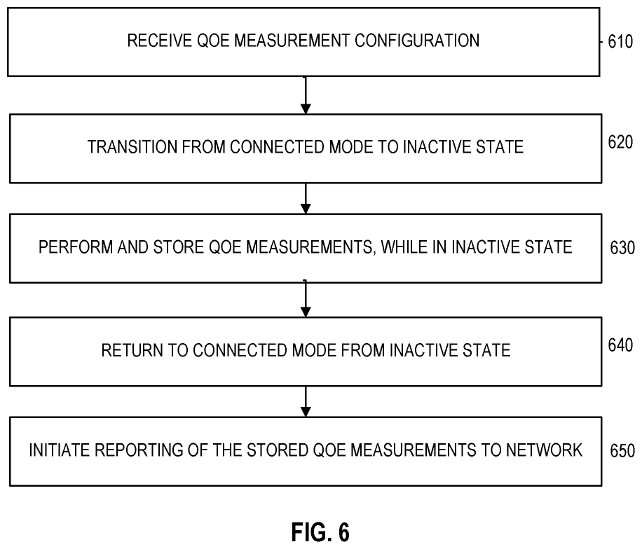

FIG. 4, FIG. 5, and FIG. 6 illustrate process flow diagrams corresponding to example methods carried out by a user equipment (UE) operating in a network, according to some of the techniques described above. Again, the illustrated methods are intended to be generalizations of and to encompass the various techniques described above, from the perspective of the UE. Thus, where the terminology used to describe the method of FIGS. 4-6 and their variants differs from that used above, the former should be understood to be a generalization of and/or to encompass the latter. Likewise, the discussion below does not address all of the possible variants and details of the illustrated methods-all of the variants and details provided above may be applied to various embodiments of the methods shown in the figures.

Starting with FIG. 4, an example method, in a UE, for handling quality-of-experience (QoE) measurement reporting, may comprise, as shown at block 410, the step of receiving, from a network node in the network, a QoE measurement configuration, where the QoE measurement configuration comprises one or more attributes indicative of at least one absolute priority or relative priority for one or more QoE measurements. The method further comprises the step of, responsive to at least a first condition, pausing reporting of one or more of the QoE measurements, based on the one or more attributes. This is shown at block 420.

In some embodiments or instances, the method may further comprise the step of, responsive to at least a second condition, resuming reporting of one or more of the QoE measurements, based on the one or more attributes. This is shown at block 430.

Note that the method shown in FIG. 4 illustrates a technique whereby the UE determines whether to pause and/or resume QoE measurement reporting, according to one or more conditions that might comprise, for example, loading conditions in the UE and/or in the network. This technique may complement or replace, in various embodiments, techniques as described above whereby the second network node (e.g., a RAN node), makes these determinations.

FIG. 5 illustrates another method, in a UE operating in a network, for handling quality-of-experience (QoE) measurement reporting. This method comprises, as shown at block 610, the step of receiving, from a network node in the network, a QoE measurement configuration. This method further comprises, as shown at block 520, the step of selecting, based on one or more attributes included in the QoE measurement configuration, from among multiple network nodes to which the

UE is connected, a network node to which QoE measurements according to the QoE measurement configuration are to be reported. This technique may complement any of the techniques described above, in various embodiments or instances.

FIG. 6 illustrates another method, in a UE operating in a network, for handling quality-of-experience (QoE) measurement reporting. This method may complement or combine with any of the other UE-based methods described herein. As shown at block 610, the method comprises receiving, from a network node in the network, a QoE measurement configuration. As shown at block 620, the method comprises transitioning from connected mode to an inactive state, with respect to the network. While in inactive state, the UE performs and stores QoE measurements, as shown at block 630. As shown at block 640, the method comprises returning to connected mode from the inactive state. And, as shown at block 650, the UE then initiates reporting of the stored QoE measurements to network, in response to the return to connected mode.

In some embodiments or instances of this method, the QoE measurement configuration comprises one or more attributes indicative of at least one absolute priority or relative priority for one or more QoE measurements, and initiating reporting for the QoE measurements comprises reporting one or more QoE measurements according to the one or more attributes. In other embodiments or instances, initiating reporting of the QoE measurements comprises sending, to the network, an indication of the availability of one or more QoE measurements for reporting. In still other embodiments or instances, one or more attributes indicative of at least one absolute priority or relative priority for one or more QoE measurements are preconfigured in the UE, and initiating reporting of the QoE measurements comprises reporting one or more QoE measurements according to the one or more attributes.

The techniques described herein may be implemented in a system comprising a plurality of network nodes including at least a first network node and a second network node, where the system is adapted to carry out a method according to any one of the methods described above. Likewise, it will be appreciated that various network nodes may be adapted to perform the role of the first network node according to the methods described above. Similarly, a network node may be adapted to perform the role of the second network node according to any of the methods described above, or to perform the role of the third network node in those variants involving a third network node.

In various implementations, any of these network nodes may comprise interface circuitry configured to communicate with one or more other network nodes, as well as processing circuitry operatively coupled to the interface circuitry and configured to carry out the operations of any one of the network nodes, according to the disclosed techniques. Similarly, a UE apparatus may be adapted to carry out operations described above, e.g., according to the methods shown in FIGS. 5 and 6. In some embodiments, for example, such a UE apparatus may comprise radio circuitry configured to communicate with a wireless network, and processing circuitry operatively coupled to the radio circuitry and configured to carry out a method according to any one of the techniques described above.

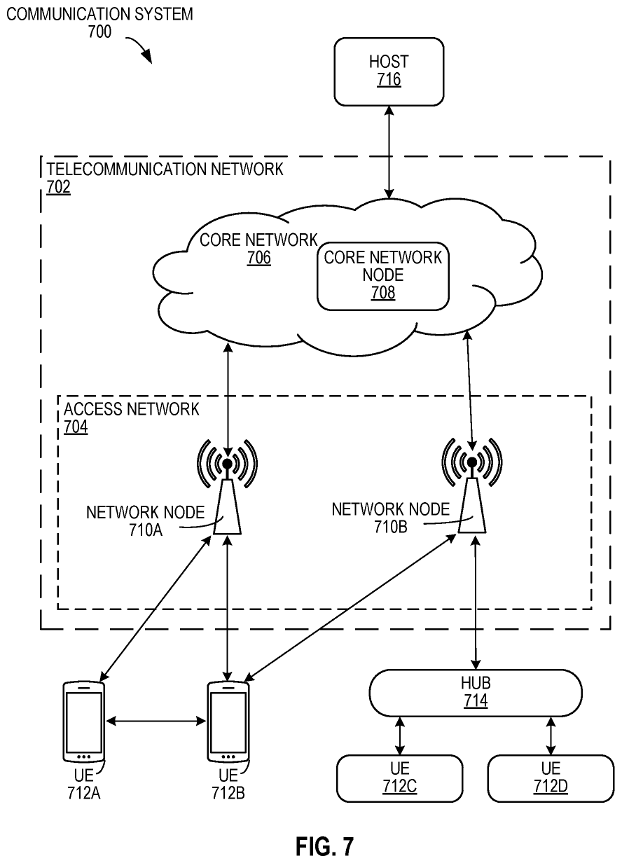

FIG. 7 shows an example of a communication system 700 in accordance with some embodiments—various nodes as illustrated here may be configured to carry out one or more of the techniques described above.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3rd Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 7G, 8G standards, or any applicable future generation standard (e.g., 9G); wireless local area network (WLAN) standards, such as the Institute of Electrical and Electronics Engineers (IEEE) QQQ02.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

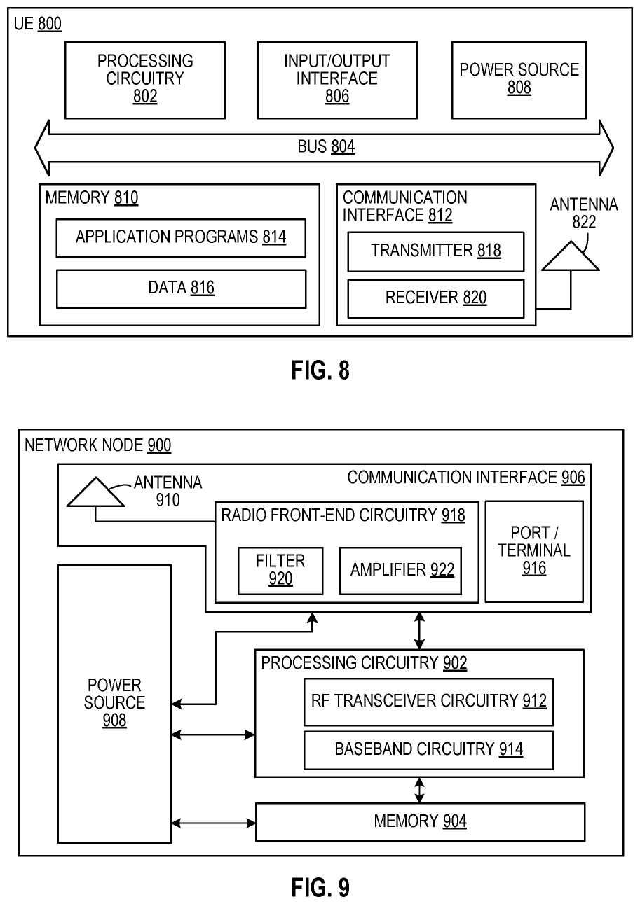

FIG. 8 shows a UE 800 in accordance with some embodiments, which may be configured to carry out one or more of the UE-related techniques described herein. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAS), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof.

The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE QQQ02.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. Various embodiments of the illustrated network node 900 may be configured to carry out the roles of the first, second, and third network nodes discussed above, for execution of one or more of the presently disclosed techniques. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 8G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

### EXAMPLE EMBODIMENTS

Embodiments of the techniques, apparatuses, and systems described above include, but are not limited to, the following enumerated examples:
1. A method, in a network, for handling quality-of-experience (QoE) measurement reporting, the method comprising: a first network node assembling a QoE measurement configuration, the QoE measurement configuration comprising one or more attributes indicative of at least one absolute priority or relative priority for one or more QoE measurements; the first network node sending the QoE measurement configuration towards a second network node; the second network node configuring one or more user equipments (UEs) to perform QoE measurements, based on the QoE measurement configuration; and the second network node, responsive to at least a first load condition in or associated with the second network node, signaling one or more of the UEs to pause reporting of one or more of the QoE measurements, based on the one or more attributes.
2. The method of example embodiment 1, wherein the second network node signals one or more of the UEs to pause reporting of the one or more of the QoE measurements based further on which of two or more radio access technologies (RATs) the at least one of the UEs is using, and/or based on a speed of each of the at least one of the UEs.
3. The method of example embodiment 1 or 2, wherein the second network node signals one or more of the UEs to pause reporting of the one or more of the QoE measurements based on a reporting frequency for each of the at least one of the UEs.
4. The method of any one of example embodiments 1-3, wherein the second network node signals one or more of the UEs to pause reporting of the one or more of the QoE measurements according to any one or more of the following: a loop cycle of a consumer of the QoE measurements for the UE; reporting periodicity for the QoE measurements; an indication of whether periodic QOE measurement reporting or QoE measurement reporting at the end of a session is expected for the UE; an expected report size for the QoE measurements for the UE; number of QoE reports expected to be sent during a session; average duration of a session; expected frequency of sessions; expected number of QoE reports per time for the consumer of the QoE measurements; expected number of QoE reports per UE for the consumer of the QoE measurements; a number or distribution of radio access network (RAN) nodes to which the consumer has provided QoE configuration; a number of UEs the second network node has configured QoE reporting and/or with a given QoE configuration; a number of QoE measurement reports the second network node has already forwarded for a certain QoE configuration; and a number of complete application sessions for which QoE reports have been received and reported.
5. The method of any one example embodiments 1-4, wherein the method further comprises: the second network node, responsive to at least a second load condition in or associated with the second network node, signaling one or more of the UEs to resume reporting of one or more of the QoE measurements, based on the one or more attributes.
6. The method of any one of example embodiments 1-5, wherein the first network node is a consumer of QoE measurement reports and is outside of any Operations and Management (OAM) system in or associated with the network.
7. The method of any one of example embodiments 1-6, wherein the second network node is a Radio Access Network (RAN) node, and wherein configuring the one or more UEs to perform QoE measurements comprises delivering all or part of the QoE measurement configuration to each of the one or more UEs.
8. The method of example embodiment 7, wherein delivering all or part of the QoE measurement to each of the one or more UEs comprises omitting at least one of the one or more attributes.
9. The method of example embodiment 7 or 8, wherein delivering all or part of the QoE measurement to each of the one or more UEs comprises including one or more attributes that implicitly or explicitly indicate to the UE to which network node, of multiple network nodes to which the UE is connected, one or more QoE measurements are to be reported.
10. The method of any one of example embodiments 1-9, wherein sending the QoE measurement configuration towards the second network comprises sending the QoE measurement configuration towards a third network node, for subsequent forwarding towards the second network node.
11. The method of example embodiment 10, wherein the method comprises: the third network node amending the QoE measurement configuration before forwarding towards the second network node, without altering the one or more attributes indicative of the at least one absolute priority or relative priority for the one or more QoE measurements.
12. The method of example embodiment 10, wherein the method comprises: the third network node amending the QoE measurement configuration before forwarding towards the second network node, wherein said amending comprises altering the one or more attributes indicative of the at least one absolute priority or relative priority for the one or more QoE measurements.
13. The method of example embodiment 12, wherein the method comprises the third network node altering the one or more attributes indicative of the at least one absolute priority or relative priority for the one or more QoE measurements by: sorting priorities and/or priority-related attributes for multiple QoE measurement configurations, including the QoE measurement configuration, and recalculating the one or more attributes indicative of the at least one absolute priority or relative priority for the one or more QoE measurements, based on said sorting, and/or adding an additional one or more attributes indicative of the at least one absolute priority or relative priority for the one or more QoE measurements, based on said sorting; and including the altered one or more attributes and/or the additional one or more attributes in the QoE measurement configuration before forwarding towards the second network node.
14. A method, in a user equipment (UE) operating in a network, for handling quality-of-experience (QoE) measurement reporting, the method comprising: receiving, from a network node in the network, a QoE measurement configuration, the QoE measurement configuration comprising one or more attributes indicative of at least one absolute priority or relative priority for one or more QoE measurements; and responsive to at least a first condition, pausing reporting of one or more of the QoE measurements, based on the one or more attributes.
15. The method of example embodiment 14, wherein the method further comprises: responsive to at least a second condition, resuming reporting of one or more of the QoE measurements, based on the one or more attributes.
16. A method, in a user equipment (UE) operating in a network, for handling quality-of-experience (QoE) measurement reporting, the method comprising: receiving, from a network node in the network, a QoE measurement configuration; and based on one or more attributes included in the QoE measurement configuration, selecting, from among multiple network nodes to which the UE is connected, a network node to which QoE measurements according to the QoE measurement configuration are to be reported.
17. A method, in a user equipment (UE) operating in a network, for handling quality-of-experience (QoE) measurement reporting, the method comprising: receiving, from a network node in the network, a QoE measurement configuration; transitioning from connected mode to an inactive state, with respect to the network; performing QoE measurements while in the inactive state; storing the QoE measurements performed while in the inactive state; returning to connected mode from the inactive state; and initiating reporting of the stored QoE measurements to network, in response to said returning.
18. The method of example embodiment 17, wherein the QoE measurement configuration comprises one or more attributes indicative of at least one absolute priority or relative priority for one or more QoE measurements, and wherein initiating reporting of the QoE measurements comprises reporting one or more QoE measurements according to the one or more attributes.
19. The method of example embodiment 17, wherein initiating reporting of the QoE measurements comprises sending, to the network, an indication of the availability of one or more QoE measurements for reporting.
20. The method of example embodiment 17, wherein one or more attributes indicative of at least one absolute priority or relative priority for one or more QoE measurements are preconfigured in the UE, and wherein initiating reporting for the QoE measurements comprises reporting one or more QoE measurements according to the one or more attributes.
21. A system comprising a plurality of network nodes including at least a first network node and a second network node, the system being adapted to carry out a method according to any one of example embodiments 1-13.
22. A network node adapted to
perform the role of the first network node according to the method of any one of example embodiments 1-13.
23. A network node adapted to perform the role of the second network node according to the method of any one of example embodiments 1-13.
24. A network node adapted to perform the role of the third network node according to the method of any one of example embodiments 8-13.
25. A network node according to any one of example embodiments 22-24, wherein the network node comprises interface circuitry configured to communicate with one or more other network nodes and further comprises processing circuitry operatively coupled to the interface circuitry and configured to carry out the operations of the network node according to the respective example embodiment of example embodiments 22-24.
26. A user equipment (UE) apparatus adapted to carry out a method according to any one of example embodiments 14-20.
27. A user equipment (UE) apparatus comprising: radio circuitry configured to communicate with a wireless network; and processing circuitry operatively coupled to the radio circuitry and configured to carry out a method according to any one of example embodiments 14-20.

### Abbreviations

### Abbreviation Explanation

3GPP 3^{rd} Generation Partnership Project
5G 5^{th} Generation
5GC/5GCN 5G Core network
5GS 5^{th} Generation System
AF Application Function
AMF Access and Mobility Management Function
AN Access Network
API Application Programming Interface
ASN.1 Abstract Syntax Notation One
AT Attention
AR Augmented Reality
AS Access Stratum
BAP Backhaul Adaptation Protocol
CA Carrier Aggregation
CE Control Element
CGI Cell Global Identity
CHO Conditional Handover
CN Core Network
CP Control Plane
CPC Conditional PSCell Change
CU Central Unit
CU-CP Central Unit Control Plane
CU-UP Central Unit User Plane
DAPS Dual Active Protocol Stacks
DASH Dynamic Adaptive Streaming over HTTP
DC Dual Connectivity
DL Downlink
DRB Data Radio Bearer
DNS Domain Name System
DU Distributed Unit
E-CGI E-UTRAN CGI
eNB Evolved Node B/E-UTRAN Node B
en-gNB A gNB acting as a secondary node in an EN-DC scenario (i.e., in a DC scenario with an eNB as the master node and a gNB as the secondary node.
EN E-UTRAN-NR
EN-DC E-UTRA-NR Dual Connectivity
EPC Evolved Packet Core
EPS Evolved Packet System
E-UTRA Evolved UTRA
E-UTRAN/EUTRAN Evolved UTRAN
gNB Radio base station in NR
GNSS Global Navigation Satellite System
GPS Global Positioning System
HSS Home Subscriber Server
HTTP Hypertext Transfer Protocol
IAB Integrated Access and Backhaul
ID Identifier/Identity
IE Information Element
KPI Key Performance Index
LTE Long Term Evolution
MAC Medium Access Control
MBS Multicast Broadcast Service
MCC Mobile Country Code
MCE Measurement Collection Entity/Measurement Collector Entity
MCG Master Cell Group
MDT Minimization of Drive Tests
MME Mobility Management Entity
MN Master Node
MNC Mobile Network Code
MR-DC Multi-Radio Dual Connectivity
MTSI Multimedia Telephony Service for IMS
N3IWF Non-3GPP Interworking Function
NG Next Generation
NE-DC NR-E-UTRA Dual Connectivity
NEF Network Exposure Function
NG Next Generation/Interface between an NG-RAN and 5GC
NGAP NG Application Protocol
NGEN-DC NG-RAN E-UTRA-NR Dual Connectivity
NG-RAN NG Radio Access Network
NID Network identifier
NR New Radio
NWDAF Network Data Analytics Function
O&M Operation and Maintenance
OAM Operation and Maintenance
PCell Primary Cell
PCF Policy Control Function
PCI Physical Cell Identity
PDCP Packet Data Convergence Protocol
PDU Protocol Data Unit
PLMN Public Land Mobile Network
PSCell Primary Secondary Cell
PTM Point to Multipoint
PTP Point to Point
QCI QoS Class Identifier
QFI QoS Flow Identifier
QMC QoE Measurement Collection
QoE Quality of Experience
QoS Quality of Service
RACH Random Access Channel
RAN Radio Access Network
RAT Radio Access Technology
RLC Radio Link Control
RNC Radio Network Controller
RRC Radio Resource Control
RSRP Reference Signal Received Power
RSRQ Reference Signal Received Quality
RSSI Received Signal Strength Indicator
RVQoE RAN-visible QoE
S1 The interface between the RAN and the CN in LTE.
S1AP S1 Application Protocol
Scell Secondary Cell
SCG Secondary Cell Group
SDT Small Data Transmission
SINR Signal to Interference and Noise Ratio
SMF Session Management Function
SMO Service Management and Orchestration
SN Secondary Node
SNR Signal to Noise Ratio
S-NSSAI Single Network Slice Selection Assistance Information
SRB Signaling Radio Bearer
TA Tracking Area
TAC Tracking Area Code
TAI Tracking Area Identity
TCE Trace Collection Entity/Trace Collector Entity
TE Terminal Equipment
TNGF Trusted Non-3GPP Gateway Function
TS Technical Specification
TWIF Trusted WLAN Interworking Function
UDM Unified Data Management
UE User Equipment
UMTS Universal Mobile Telecommunication System
URI Uniform Resource Identifier
URL Uniform Resource Locator Uniform Resource Locator
URLLC Ultra-Reliable Low-Latency Communication
UTC Universal Coordinated Time
UTRA Universal Terrestrial Radio Access
UTRAN Universal Terrestrial Radio Access Network
VR Virtual Reality
WLAN Wireless Local Area Network
Xn The interface between two gNBs in NR.
XML Extensible Markup Language
XnAP Xn Application Protocol

1-38. (canceled)

39. A method, in a network, for handling quality-of-experience (QoE) measurement reporting, the method comprising:
a first network node assembling a QoE measurement configuration, the QoE measurement configuration comprising one or more attributes indicative of at least one absolute priority or relative priority for one or more QoE measurements;
the first network node sending the QoE measurement configuration towards a second network node;
the second network node configuring one or more user equipments (UEs) to perform QoE measurements, based on the QoE measurement configuration;
the second network node, responsive to at least a first load condition in or associated with the second network node, signaling one or more of the UEs to pause reporting of one or more of the QoE measurements, based on the one or more attributes.

40. The method of claim 39, wherein the second network node signals one or more of the UEs to pause reporting of the one or more of the QoE measurements based further on which of two or more radio access technologies (RATs) the at least one of the UEs is using, and/or based on a speed of each of the at least one of the UEs.

41. The method of claim 39, wherein the second network node signals one or more of the UEs to pause reporting of the one or more of the QoE measurements based on a reporting frequency for each of the at least one of the UEs.

42. The method of claim 39, wherein the second network node signals one or more of the UEs to pause reporting of the one or more of the QoE measurements according to any one or more of the following:
a loop cycle of a consumer of the QoE measurements for the UE;
reporting periodicity for the QoE measurements;
an indication of whether periodic QOE measurement reporting or QoE measurement reporting at the end of a session is expected for the UE;
an expected report size for the QoE measurements for the UE;
number of QoE reports expected to be sent during a session;
average duration of a session;
expected frequency of sessions;
expected number of QoE reports per time for the consumer of the QoE measurements;
expected number of QoE reports per UE for the consumer of the QoE measurements;
a number or distribution of radio access network (RAN) nodes to which the consumer has provided QoE configuration;
a number of UEs the second network node has configured QoE reporting and/or with a given QoE configuration;
a number of QoE measurement reports the second network node has already forwarded for a certain QoE configuration; and
a number of complete application sessions for which QoE reports have been received and reported.

43. The method of claim 39, wherein the method further comprises:
the second network node, responsive to at least a second load condition in or associated with the second network node, signaling one or more of the UEs to resume reporting of one or more of the QoE measurements, based on the one or more attributes.

44. The method of claim 39, wherein the first network node is a consumer of QoE measurement reports and is outside of any Operations and Management (OAM) system in or associated with the network.

45. The method of claim 39, wherein sending the QoE measurement configuration towards the second network comprises sending the QoE measurement configuration towards a third network node, for subsequent forwarding towards the second network node.

46. The method of claim 45, wherein the method comprises:
the third network node amending the QoE measurement configuration before forwarding towards the second network node, without altering the one or more attributes indicative of the at least one absolute priority or relative priority for the one or more QoE measurements.

47. The method of claim 45, wherein the method comprises:
the third network node amending the QoE measurement configuration before forwarding towards the second network node, wherein said amending comprises altering the one or more attributes indicative of the at least one absolute priority or relative priority for the one or more QoE measurements.

48. The method of claim 47, wherein the method comprises the third network node altering the one or more attributes indicative of the at least one absolute priority or relative priority for the one or more QoE measurements by:
sorting priorities and/or priority-related attributes for multiple QoE measurement configurations, including the QoE measurement configuration, and recalculating the one or more attributes indicative of the at least one absolute priority or relative priority for the one or more QoE measurements, based on said sorting, and/or adding an additional one or more attributes indicative of the at least one absolute priority or relative priority for the one or more QoE measurements, based on said sorting; and
including the altered one or more attributes and/or the additional one or more attributes in the QoE measurement configuration before forwarding towards the second network node.

49. A method, in a user equipment (UE) operating in a network, for handling quality-of-experience (QoE) measurement reporting, the method comprising:
receiving, from a network node in the network, a QoE measurement configuration, the QoE measurement configuration comprising one or more attributes indicative of at least one absolute priority or relative priority for one or more QoE measurements; and
responsive to at least a first condition, pausing reporting of one or more of the QoE measurements, based on the one or more attributes.

50. The method of claim 49, wherein the method further comprises:
responsive to at least a second condition, resuming reporting of one or more of the QoE measurements, based on the one or more attributes.

51. A system comprising a plurality of network nodes including at least a first network node and a second network node, the system being configured to carry out the method of claim 39.

52. A first network node for handling quality of experience (QoE) measurement reporting, the first network node comprising processing circuitry and communications interface circuitry, the processing circuitry and communications interface circuitry being configured to:
assemble a QoE measurement configuration, the QoE measurement configuration comprising one or more attributes indicative of at least one absolute priority or relative priority for one or more QoE measurements;
send the QoE measurement configuration towards a second network node.

53. A second network node for handling quality of experience (QoE) measurement reporting, the second network node comprising processing circuitry and communications interface circuitry, the processing circuitry and communications interface circuitry being configured to:
receive, from a first network node, a QoE measurement configuration, the QoE measurement configuration comprising one or more attributes indicative of at least one absolute priority or relative priority for one or more QoE measurements;
configure one or more user equipments (UEs) to perform QoE measurements, based on the QoE measurement configuration; and,
responsive to at least a first load condition in or associated with the second network node, signal one or more of the UEs to pause reporting of one or more of the QoE measurements, based on the one or more attributes.

54. A third network node for handling quality of experience (QoE) measurement reporting, the third network node comprising processing circuitry and communications interface circuitry, the processing circuitry and communications interface circuitry being configured to:
receive, from a first network node, a QoE measurement configuration, the QoE measurement configuration comprising one or more attributes indicative of at least one absolute priority or relative priority for one or more QoE measurements; and
subsequently forward the QoE measurement configuration towards a second network node.
